(19) United States
(12) Patent Application Publication
(10) Pub. No.: US 2026/0147454 A1
(43) Pub. Date: May 28, 2026

(54) INFORMATION PROCESSING APPARATUS, TERMINAL APPARATUS, INFORMATION PROCESSING SYSTEM, AND INFORMATION PROCESSING METHOD

(71) Applicant: Tatsuma HIROKAWA, Kanagawa (JP)

(72) Inventor: Tatsuma HIROKAWA, Kanagawa (JP)

(21) Appl. No.: 19/328,233

(22) Filed: Sep. 15, 2025

(30) Foreign Application Priority Data
Nov. 28, 2024 (JP) 2024-206998

(51) Int. Cl. G06F 3/0484; G06F 3/0481; G06F 3/0482; G06F 9/54; G06F 40/166

(52) U.S. Cl. CPC G06F 3/0484; G06F 3/0481; G06F 9/543; G06F 40/166; G06F 3/0482

(57) ABSTRACT

An information processing apparatus includes circuitry that registers information input via a screen including a plurality of input fields for receiving inputs of data for a plurality of items from a user, including a specific input field for receiving input of text, the screen receiving an instruction to generate the text to be input to the specific input field, and in a case where the instruction is received, transmits a request to a generative AI system, including information indicating one or more items other than a specific item of the specific input field, and an instruction to generate the text to be input to the specific input field of the specific item based on the information indicating the one or more items, receives the text to be input to the specific input field from the generative AI system, and transmits the text based on the request to a terminal apparatus.

### CROSS-REFERENCE TO RELATED APPLICATIONS

This patent application is based on and claims priority pursuant to 35 U.S.C. § 119(a) to Japanese Patent Application No. 2024-206998, filed on Nov. 28, 2024, in the Japan Patent Office, the entire disclosure of which is hereby incorporated by reference herein.

### BACKGROUND

### Technical Field

The present disclosure relates to an information processing apparatus, a terminal apparatus, an information processing system, and an information processing method.

### Related Art

Artificial intelligence (AI) technology, so-called generative AI, is used for generating data such as text data, image data, and audio data. Generative AI uses relationships between patterns and pieces of data that the generative AI has learned in the generation of new data such as new text data.

Techniques that use generative AI to assist in the creation work are conceived. For example, generative AI outputs a title in response to input of a genre and a keyword, or outputs a summary in response to input of a title and a keyword.

### SUMMARY

The present disclosure described herein provides an information processing apparatus communicably connected with a terminal apparatus and a generative AI system via a network, the information processing apparatus including: circuitry that: registers information input via a screen displayed by the terminal apparatus, the screen including a plurality of input fields for receiving inputs of data for a plurality of items from a user, the plurality of input fields including a specific input field for receiving input of text, the screen receiving an instruction to generate the text to be input to the specific input field; and in a case where the instruction is received from the user, transmit a request to the generative AI system, the request including information indicating one or more items of the plurality of items other than a specific item of the specific input field, and an instruction to generate the text to be input to the specific input field of the specific item based on the information indicating the one or more items; receives the text to be input to the specific input field from the generative AI system in response to the request; and transmits the text generated by the generative AI system based on the request to the terminal apparatus.

The present disclosure described herein provides an information processing system including the information processing apparatus described above and the terminal apparatus communicatively connected with the information processing apparatus via the network.

The present disclosure described herein provides a terminal apparatus communicably connected with an information processing apparatus via a network, the terminal apparatus including circuitry that: displays a screen, the screen including a plurality of input fields for receiving inputs of data for a plurality of items from a user, the plurality of input fields including a specific input field for receiving input of text, the screen receiving an instruction to generate the text to be input to the specific input field; in a case where the instruction is received on the screen, transmits a request to the information processing apparatus, the request including information indicating one or more items of the plurality of items other than a specific item of the specific input field, data input by the user in one or more input fields corresponding to the one or more items, and an instruction to generate the text to be input to the specific input field of the specific item, based on the information indicating the one or more items and the data input in the one or more input fields; receives the text to be input to the specific input field from the information processing apparatus, the text being acquired in response to the information processing apparatus transmitting the request to a generative AI system; inputs the received text to the specific input field; and transmits the text input in the specific input field to the information processing apparatus, the text to be managed by the information processing apparatus.

The present disclosure described herein provides an information processing method including: registering information input via a screen displayed by a terminal apparatus, the screen including a plurality of input fields for receiving inputs of data for a plurality of items from a user, the plurality of input fields including a specific input field for receiving input of text, the screen receiving an instruction to generate the text to be input to the specific input field. In a case where the instruction is received from the user, the method further includes: transmitting a request to a generative AI system, the request including information indicating one or more items of the plurality of items other than a specific item of the specific input field, data input by the user in one or more input fields corresponding to the one or more items, and an instruction to generate the text to be input to the specific input field of the specific item, based on the information indicating the one or more items and the data input in the one or more input fields; receiving the text to be input to the specific input field from the generative AI system in response to the request; and transmitting the text generated by the generative AI system based on the request to the terminal apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of an application creation screen displayed by a user terminal;

FIG. 2 is a diagram illustrating an example of an input screen of a business trip report application displayed by the user terminal;

FIG. 3 is a diagram for describing a procedure in which a user inputs values to input items of the business trip report application;

FIG. 4 is a diagram for describing a procedure of an information setting service provided by an information processing system;

FIG. 5 is a diagram illustrating an example of a system configuration of the information processing system;

FIG. 6 is a diagram illustrating an example of a hardware configuration of an application service, the user terminal, and a developer terminal;

FIG. 7 is a diagram illustrating an example of a functional configuration of the application service and the user terminal;

FIG. 8 is a diagram illustrating an example of information set for input items of an application;

FIG. 9 is a diagram illustrating an example of information related to the input items of the application;

FIG. 10 is a sequence diagram for describing an example of a process performed by the information processing system;

FIG. 11 is a diagram illustrating an example of parameters included in a request message transmitted by the application service to a generative AI system in step S4 in FIG. 10;

FIG. 12 is a diagram for describing a prompt set in “prompt” in FIG. 11;

FIG. 13 is a diagram illustrating a format of a response message transmitted by the generative AI system to the application service in step S5 in FIG. 10;

FIG. 14 is a diagram illustrating an example of the input screen of the business trip report application displayed by the user terminal;

FIG. 15 is a diagram illustrating an example of the prompt generated by a request generation unit;

FIG. 16 is a diagram illustrating an example of a response message from the generative AI system in response to a request message including the prompt illustrated in FIG. 15;

FIG. 17 is a diagram illustrating an example of the input screen of the business trip report application in which a generated value is set in a daily report field of the business trip report application;

FIG. 18 is a diagram illustrating an example of an input screen of a preschool newsletter creation application displayed by the user terminal;

FIG. 19A is a diagram illustrating an example of information related to input items of the preschool newsletter creation application;

FIG. 19B is a diagram illustrating an example of information set for the input items of the preschool newsletter creation application;

FIG. 20 is a diagram illustrating an example of a prompt generated by the request generation unit;

FIG. 21 is a diagram illustrating an example of a response message from the generative AI system in response to a request message including the prompt illustrated in FIG. 20;

FIG. 22 is a diagram illustrating an example of the input screen of the preschool newsletter creation application in which a generated value is set in a newsletter text field of the preschool newsletter creation application;

FIG. 23 is a diagram illustrating an example of the input screen of the business trip report application displayed by the user terminal;

FIG. 24 is a diagram illustrating an example of a prompt generated by the request generation unit;

FIG. 25 is a diagram illustrating an example of a prompt input screen displayed as a pop-up window over the input screen of the business trip report application;

FIG. 26 is a diagram illustrating an example of a prompt in a request message generated by the request generation unit;

FIG. 27 is a diagram illustrating an example of a confirmation dialog displayed as a pop-up window over the input screen of the business trip report application;

FIG. 28 is a diagram illustrating an example of an input item selection dialog displayed as a pop-up window over the input screen of the business trip report application;

FIG. 29 is a diagram illustrating an example of a prompt generated by the request generation unit;

FIG. 30 is a diagram illustrating an example of a prompt generated by the request generation unit;

FIG. 31 is a diagram illustrating an example of the input screen of the preschool newsletter creation application displayed by the user terminal;

FIG. 32 is a diagram illustrating an example of a generation target selection dialog displayed as a pop-up window over the input screen of the preschool newsletter creation application;

FIG. 33 is a diagram illustrating an example of a prompt generated by the request generation unit;

FIG. 34 is a diagram illustrating an example of a response message from the generative AI system in response to a request message including the prompt illustrated in FIG. 33;

FIG. 35 is a diagram illustrating an example of the input screen of the preschool newsletter creation application in which generated values are set in the preschool newsletter creation application;

FIG. 36 is a diagram illustrating an example of a prompt using few-shot prompting; and

FIG. 37 is a sequence diagram for describing an example of a process performed by the information processing system when few-shot prompting is used.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A setting method performed by an information processing system will be described below as an example of embodiments of the present disclosure.

### Application Service

An application service is a service for assisting a user in creating applications in a low-code or no-code manner. Such a service is also called visual programming. The application service transmits a web application for assisting in creating applications to a user terminal operated by the user. This allows the user to operate the web application executed on the user terminal to create various applications.

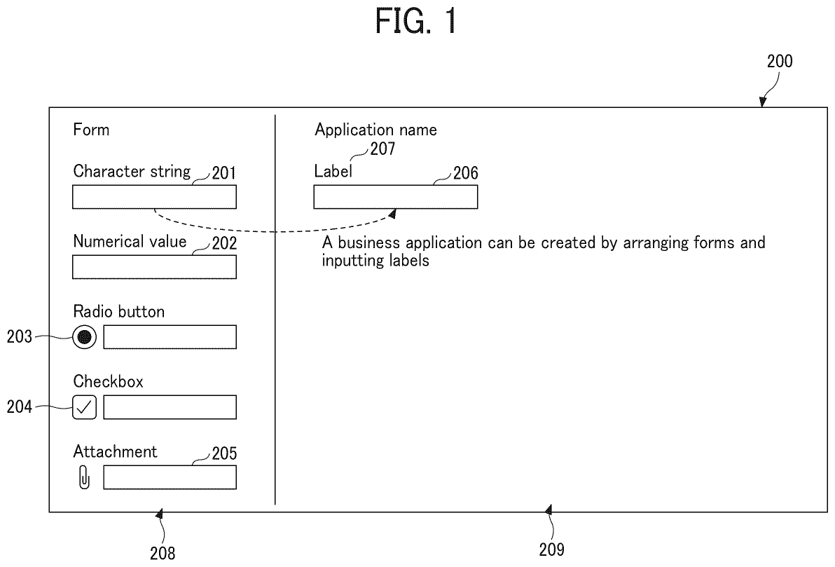

FIG. 1 illustrates an application creation screen 200 displayed by the user terminal. For example, the application creation screen 200 includes a form area 208 and a work area 209. The form area 208 displays a list of forms to be arranged in an application. The forms are display components of a screen. Examples of the forms include a text input form, a selection form, and a file registration form. FIG. 1 illustrates a character string form 201, a numerical value form 202, a radio button form 203, a checkbox form 204, and an attachment form 205. The aforementioned forms are merely an example.

The character string form 201 is a form for inputting a character string. For example, full-width characters, half-width characters, numerical values, and symbol are input to the character string form 201.

The numerical value form 202 is a form for inputting a numerical value. Only numerical values can be input to the numerical value form 202.

The radio button form 203 is a form for a button that receives selection of one option from among a plurality of options. The radio button form 203 has a field to display an option.

The checkbox form 204 is a form for a checkbox that receives selection of one or more options from among a plurality of options. The checkbox form 204 has a field to display an option.

The attachment form 205 is a form for receiving a setting of a file to be registered to the application. The attachment form 205 may have a restriction on the format of a file to be received for registration.

The work area 209 is an area in which the user arranges forms. The user operates a mouse pointer to drag and drop a form in the form area 208 to the work area 209. Alternatively, the user operates a touch panel with their finger or stylus to drag and drop a form to the work area 209.

A form arranged in the work area 209 is referred to as an input item 206. The input item 206 has one or more input fields. For simplicity, the input field may be simply referred to as an “input item” below.

For the input item 206, a label 207 is displayed. The label 207 is a name of the input item 206. The user inputs an appropriate label for the input item 206. The user repeats this operation to create any application. For example, the user arranges the character string forms 201 in the work area 209, and inputs labels such as “traveler” and “travel date”. In this manner, the user can create a business trip report application described below. The position of the input item 206 already arranged in the work area 209 is changeable.

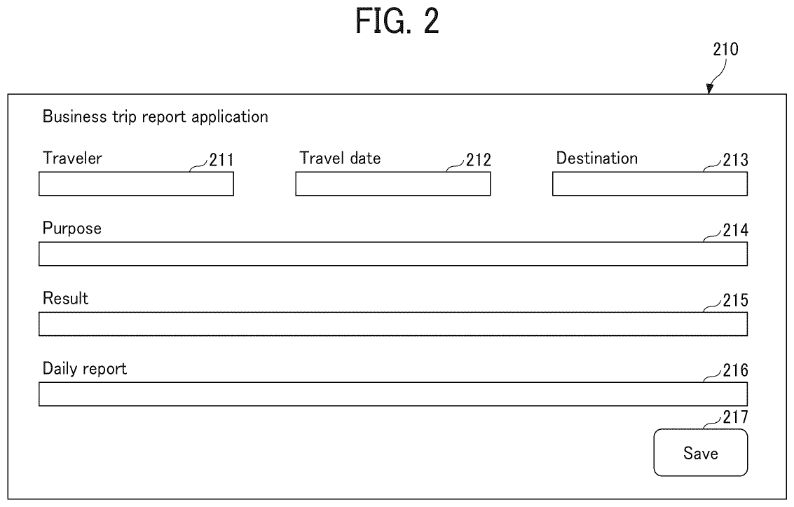

FIG. 2 illustrates an input screen 210 of the business trip report application. This business trip report application includes a traveler field 211, a travel date field 212, a destination field 213, a purpose field 214, a result field 215, a daily report field 216, and a save button 217. The items other than the save button 217 are input items. The application thus created is available to users in their work or the like. For example, an employee, who had a business trip, uses the business trip report application. The employee fills in each input item such as the traveler. In this manner, the business trip report application enables digitization of the information. Alternatively, the business trip report application enables sharing of the information among a team.

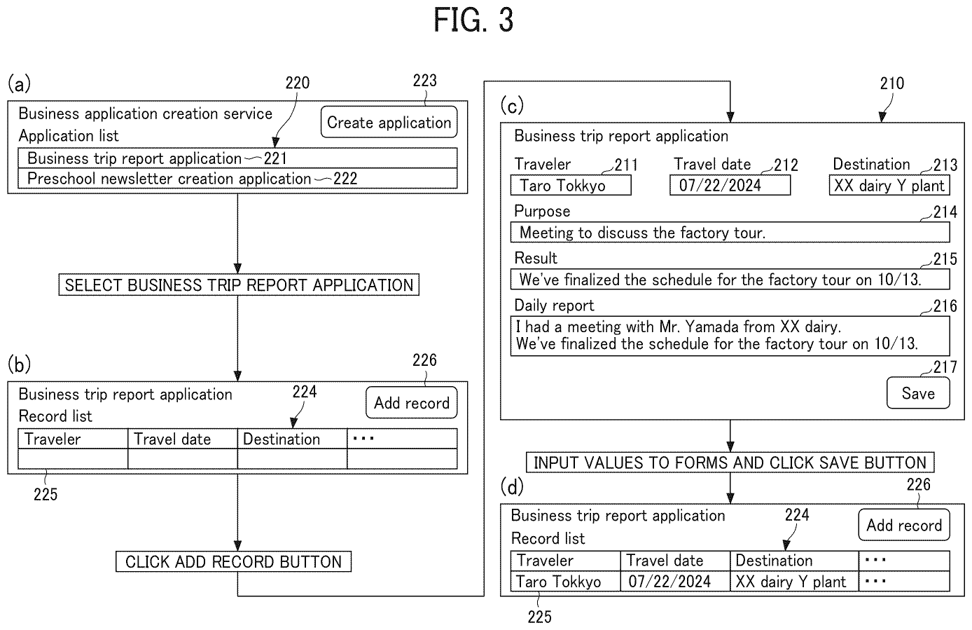

FIG. 3(a) illustrates an application list 220 displayed by the user terminal operated by the user. The application list 220 is a list of applications created and registered to the application service by users in the procedure illustrated in FIG. 1. For example, the application list 220 displays a business trip report application 221 and a preschool newsletter creation application 222. In this example, the user selects the business trip report application 221. Note that a create application button 223 is a button for displaying the screen illustrated in FIG. 1.

FIG. 3(b) illustrates a record list 224 displayed by the user terminal. The record list 224 displays, as a table, a list of pieces of business trip information registered to the business trip report application 221. A record refers to data of one row when pieces of data in a database are arranged in a two-dimensional table. One record corresponds to one piece of business trip information. A record 225 has a plurality of input items. These input items may be called fields. One vertical line of the table is referred to as a column. In FIG. 3(b), since no business trip information is registered, the record list 224 is empty.

In response to the user pressing an add record button 226, the input screen 210 of the business trip report application is displayed. FIG. 3(c) illustrates the input screen 210 of the business trip report application. As described above, the input screen 210 of the business trip report application 221 includes the input items created by the user for the business trip report application 221. The user inputs values for the respective input items, and presses the save button 217. The input content (in this case, the business trip information) is saved as a record in the application service.

FIG. 3(d) illustrates the record list 224 displayed by the user terminal. The business trip information input on the input screen 210 of the business trip report application in FIG. 3(c) is displayed as one record.

As described above, since a keyboard is usually used for input to the input items, the workload of the user is large. In addition, a mistake may occur during the input.

### Process Flow

Accordingly, in the present embodiment, the user terminal transmits, to the application service, a list of input items of an application and previously input values of the input items. The application service requests a generative AI system to generate a value. The generative AI system performs various natural language processing tasks, such as text generation, question answering, text classification, sentiment analysis, information extraction, and text summarization. An example of the generative AI system is Copilot®, which proposes codes to be written next while the user is coding a program. In the present embodiment, a technique will be described in which the generative AI system generates, from the list of input items and the previously input values of some of the input items, a value of another input item without having a conversation (also referred to as a chat) with the user. In the present disclosure, the generative AI system or the functions thereof may be simply referred to as artificial intelligence (AI).

The generative AI system analyzes the list of input items and the previously input values of the input items, generates a value to be input to a designated input item, and transmits the generated value to the application service. The application service receives the generated value, and transmits the generated value to the user terminal. The user terminal receives the generated value, and registers the generated value to the application service.

Note that the user is allowed to create any applications used for their work or the like as well as the business trip report application, by using the application service. Thus, the information processing system according to the present embodiment generates, with the generative AI system, a value appropriate for an input item of any application, and sets the generated value to the input item in the application service.

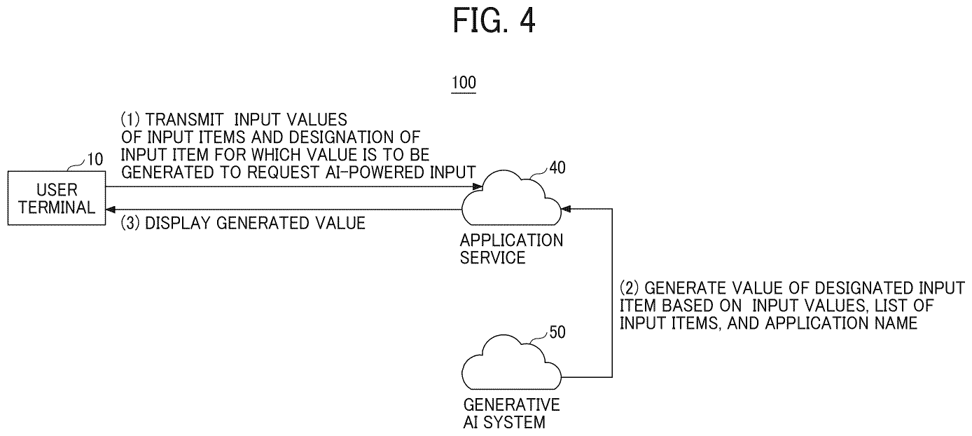

FIG. 4 is a diagram for describing a process in which an information processing system 100 sets a value to an application service 40. A user terminal 10 executes a web application. An application having an input item to which a value is to be set has already been created in the application service 40. A generative AI system 50 analyzes a list of input items of the application and previously input values of the input items, and generates a value to be set for a designated input item.

(1) The user terminal 10 displays an input screen of the application. In an example, the user is operating the business trip report application to create a business trip report and inputs values of some input items in relation to their business trip report. The user desires to automatically set a value generated by the generative AI system 50 to a specific input item. The user presses a predetermined button to transmit the previously input values of some input items and designation of the input item for which a value is to be generated to the application service 40 (requests AI-powered input). Note that the values input by the user to the input items to create the business trip report are not held in the user terminal 10 and may be acquired from the application service 40.

(2) In response to the request, the application service 40 identifies a list of input items and an application name of the application executed by the user terminal 10. In some embodiments, the application name may be omitted. In some embodiments, the application service 40 may acquire an explanation note of the application, which is an explanation of the application and set in advance by the user), instead of the application name. The application service 40 transmits application-related information (i.e., the list of input items, the previously input values, and the application name) and the input item for which a value is to be generated to the generative AI system 50. The “input item for which a value is to be generated” may be referred to as a “designated input item” below. The application service 40 acquires the value to be set for the designated input item from the generative AI system 50. Specifically, the generative AI system 50 analyzes the list of input items, the previously input values, and the application name, generates a value to be set for the designated input item, and transmits the generated value to the application service 40.

Note that the previously input values may be omitted. The generative AI system 50 generates information that the generative AI system 50 has not learned. For example, the generative AI system 50 generates a value of the designated input item from at least one of the list of input items or the application name. The generative AI system 50 generates an appropriate value of the designated input item by using few-shot prompting (described later) even when the generative AI system 50 is provided with no previously input values.

(3) The application service 40 transmits the value acquired from the generative AI system 50, to the user terminal 10. Thus, the user terminal 10 displays the input screen in which the value is set for the designated input item to allow the user to check the generated value. In response to the user pressing a register button or the like, the user terminal 10 transmits the value associated with the input item to the application service 40. The application service 40 sets the value in the record of the application.

As described above, the information processing system 100 according to the present embodiment sets a value for an input item of any application.

### Terminology

The application is an abbreviation of an application program. In the present disclosure, the application is a program generated by a computer according to a certain task. An operating system (OS) is general-purpose software that provides basic functions and systems for operations performed by the computer such as the file system, communication, and display control. The application provides specific functions while operating on the OS. Types of the application include a web application and a native application. In the present disclosure, any of the web application and the native application may be developed.

An Application Programming Interface (API) is an interface for the application (software), which functions as a contact point for connecting the systems to each other to share functions and mechanisms. The API defines the specification of an interface used by the applications to exchange information with each other. The API between the computers defines, for example, the specification for one web site to communicate with another web site by Hypertext Transfer Protocol (HTTP) or Hypertext Transfer Protocol Secure (HTTPS) communication. Through communicating, the one web site may use the functions provided by the other web site. The API between the computers may be referred to as a web-API.

When the API transmits a specific request (for example, data acquisition, update, deletion, or processing), the API returns a result (for example, data, an update result, a deletion result, or a processing result) in response to the specific request. The request may be referred to as a request message, and the result may be referred to as a response message. Calling the API means transmitting a request and acquiring a result in accordance with the specification of the API. Calling the API may also be referred to as executing, operating, tapping, or using.

A user is an end user who uses an application provided by the application service 40. The user can also develop an application. A developer is a person who makes desired settings in the application service 40 in order to allow the development of an application by no-code or low-code programming and the use of the application.

An item is each item having an input field for inputting information. In the input field, various kinds of information can be input. For example, image data, audio data, video data, a file, and information for selecting an option as well as a character string, a numerical value, and a symbol may be input. One screen may include a plurality of items and a plurality of input fields.

A specific input field that receives input of text is an input field to which a value generated by the generative AI system 50 is to be input. One or more items other than a specific item related to the specific input field are input fields other than the specific input field among the input fields of the application. For the one or more items, values input by the user may be set.

### First Embodiment

### Example of System Configuration

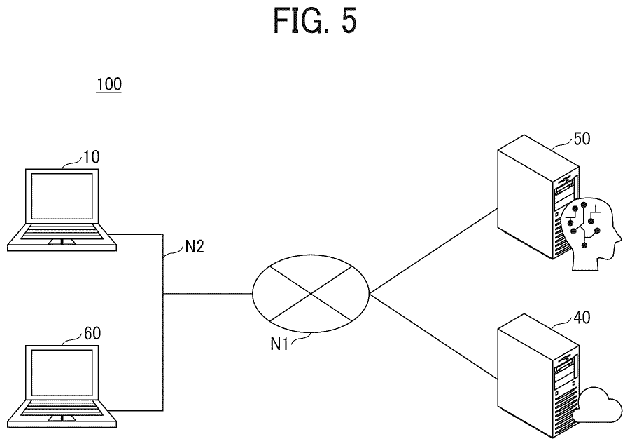

A system configuration of the information processing system 100 according to the present embodiment will be described with reference to FIG. 5. FIG. 5 is a diagram illustrating an example of the system configuration of the information processing system 100. The information processing system 100 illustrated in FIG. 5 includes the user terminal 10, a developer terminal 60, and the application service 40. The user terminal 10 and the developer terminal 60 are communicatively connected to the application service 40 via networks N1 and N2. The information processing system 100 may further include the generative AI system 50. The user terminal 10 and the developer terminal 60 are communicatively connected to the generative AI system 50 via the networks N1 and N2. The application service 40 may communicate with the generative AI system 50 via APIs.

The user terminal 10 and the developer terminal 60, which are installed at facilities such as companies or homes, are connected to the network N2. The network N2 may be a local area network (LAN), Wi-Fi®, wide-area Ethernet®, or a mobile phone network such as 4G, 5G, or 6G. The network N1 is a network for a wide area, such as Internet or a wide area network (WAN). The user terminal 10 and the developer terminal 60 are not necessarily connected to the network N2 all the time, and may be connected to the network N2 when using the generative AI system 50 or the application service 40.

The generative AI system 50 provides a service that allows a user to chat with an AI in a natural language. An example of such a generative AI system 50 is a system that uses a large language model (LLM). The LLM is a natural language processing model trained on a vast amount of text data. The generative AI system 50 receives a vast amount of text as input, and obtains knowledge from the input text by deep learning or reinforcement learning, for example. The generative AI system 50 uses this knowledge to provide a response message to a chat message. The chat message includes a prompt (described later) and image data. The prompt refers to text data in the chat message

The generative AI system 50 that generates text in response to data based on the chat message may be referred to as generative AI. In the present embodiment, the response message returned by the generative AI system 50 is used to create a value of an input item of an application that operates on the application service 40. The application that operates on the application service 40 includes a web application that operates on the application service 40 and a native application that is installed on the user terminal 10. When the native application installed on the user terminal 10 is executed by the user terminal 10, the native application is connected to the application service 40 and executes the functions of the application service 40.

The generative AI system 50 has the following features.

First, the generative AI system 50 keeps the natural flow of conversation.

Second, the generative AI system 50 can make a proposal by expanding ideas even in the field in which the user has no knowledge.

Third, the generative AI system 50 can output accurate program codes.

Taking advantage of such features, the user provides the generative AI system 50 with application-related information and designation of an input item for which a value is to be generated, and thus can obtain a value to be set for the designated input item from the generative AI system 50 via the application service 40.

Examples of the generative AI system 50 include systems that use an LLM such as GPT-3®, GPT-4®, Transformer®, and BERT®. In an example, the information processing system 100 according to the present embodiment can use ChatGPT that uses GPT-3® or GPT-4® but may use a system that uses any other LLM.

The application service 40 is one or more information processing apparatuses that provide an application to be executed by the user. The application service 40 is a server apparatus that provides an application for managing information input by the user to input fields of input items. The application provided by the application service 40 is, for example, a database-based web application that manages data in a table format. The user is allowed to create any input items of the application and customize the application to save, read, or process data related to their work. The application service 40 has a plurality of applications, and the business trip report application or the preschool newsletter creation application is one of the plurality of applications.

In the present embodiment, the user inputs values such as the date in the application in the case of the business trip report, for example. The user terminal 10 designates the daily report field for which generation of a value is desired together with these previously input values to request the application service 40 to provide AI-powered input. The application service 40 transmits the application-related information (e.g., the list of input items, the previously input values, and the application name) and the input item for which a value is to be generated to the generative AI system 50, and receives a response message (i.e., the value of the designated input item) from the generative AI system 50. The application service 40 transmits the value of the designated input item to the user terminal 10. This enables automatic setting of information, which is manually input by the user, in the application.

Examples of the application service 40 include a cloud service, an application service provider (ASP), and Software as a Service (SaaS), and may include various services to be provided via a network. Examples of the service to be provided include a database providing service and a storage service. The application service 40 may be on the Internet or on premises.

The functions of the application service 40 may be distributed to a plurality of information processing apparatuses. A plurality of application services 40 having the same functions are present, and the number of information processing apparatuses having the functions of the application services 40 may be changed in accordance with the processing load.

A web server may be present separately from the application service 40, and the web server may communicate with the user terminal 10. In this case, the web server communicates with the application service 40 on behalf of the user terminal 10.

The server is a computer or software having a function of providing information or a processing result in response to a request from a client.

The application service 40 receives various settings from the developer terminal 60. The various settings include registration of a user to the application service 40 and registration of a web application for creating a chat message. That is, an administrator (e.g., developer) performs a work in the application service 40 to enable a value of an input item of an application to be set using the generative AI system 50.

The user terminal 10 or the developer terminal 60 is, for example, a terminal apparatus such as a personal computer (PC), a smartphone, or a tablet terminal, which is operated by the user or the developer. The web browser or the native application operates on the user terminal 10 or the developer terminal 60.

The developer operates the developer terminal 60 to create setting information related to the application.

The administrator (e.g., developer) or the user operates the developer terminal 60 or the user terminal 10 to use various services provided by the generative AI system 50 or the application service 40.

The user terminal 10 or the developer terminal 60 may be an information processing apparatus. Examples of the information processing apparatus include an output apparatus such as an electronic whiteboard or a digital signage, a head-up display (HUD), an industrial machine, an imaging apparatus such as a digital camera, a sound collecting apparatus, a medical device, a network home appliance, a mobile phone, a smartphone, a tablet terminal, a car navigation system, a game machine, a personal digital assistant (PDA), and a wearable PC.

### Example of Hardware Configuration

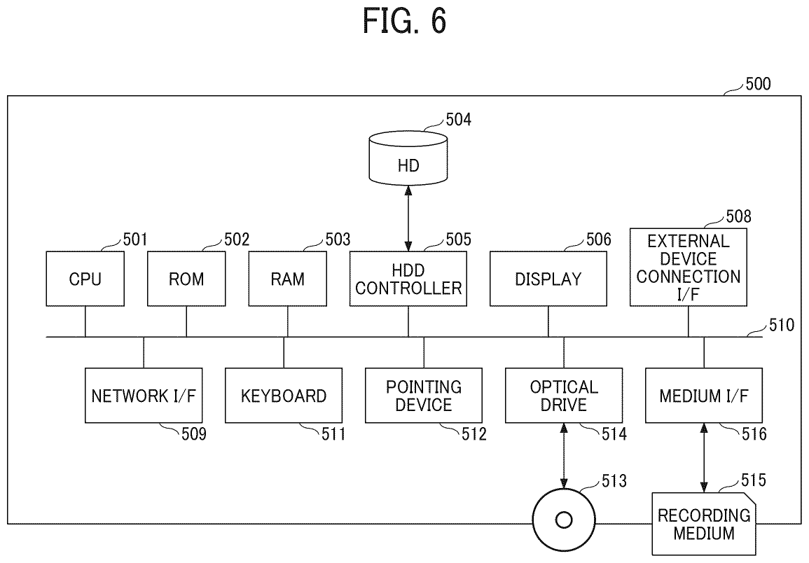

A hardware configuration of the application service 40, the user terminal 10, and the developer terminal 60 included in the information processing system 100 will be described with reference to FIG. 6. The generative AI system 50 has substantially the same hardware configuration as that illustrated in FIG. 6 or a hardware configuration of an information processing apparatus that supports cloud computing.

### Application Service, User Terminal, and Developer Terminal

FIG. 6 is a diagram illustrating an example of the hardware configuration of the application service 40, the user terminal 10, and the developer terminal 60. The application service 40, the user terminal 10, and the developer terminal 60 are each implemented by a computer 500. As illustrated in FIG. 6, the computer 500 includes a central processing unit (CPU) 501, a read-only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a medium I/F 516.

The CPU 501 controls the entire operation of the computer 500. The ROM 502 stores programs, such as an initial program loader (IPL), for driving the CPU 501. The RAM 503 is used as a work area for the CPU 501. The HD 504 stores various types of data such as a program. The HDD controller 505 controls reading or writing of various types of data from or to the HD 504 under control of the CPU 501. The display 506 displays various types of information such as a cursor, a menu, a window, characters, or an image. The external device connection I/F 508 is an interface for connecting various external devices to the computer 500. Examples of the external devices include a Universal Serial Bus (USB) memory and a printer.

The network I/F 509 is an interface for performing data communication using the network N1 or N2. The bus line 510 is, for example, an address bus or a data bus for electrically connecting the components such as the CPU 501 illustrated in FIG. 6 to one another.

The keyboard 511 is an example of an input device including a plurality of keys to be used for inputting characters, numerical values, various instructions, or the like. The pointing device 512 is an example of an input device to be used for, for example, selecting or executing various instructions, selecting a target for processing, or moving a cursor. The optical drive 514 controls reading or writing of various types of data from or to an optical storage medium 513, which serves as a removable recording medium. Examples of the optical recording medium include a digital versatile disc (DVD) and a compact disc (CD). The medium I/F 516 controls reading or writing (storing) of data from or to a recording medium 515 such as a flash memory.

### Functions

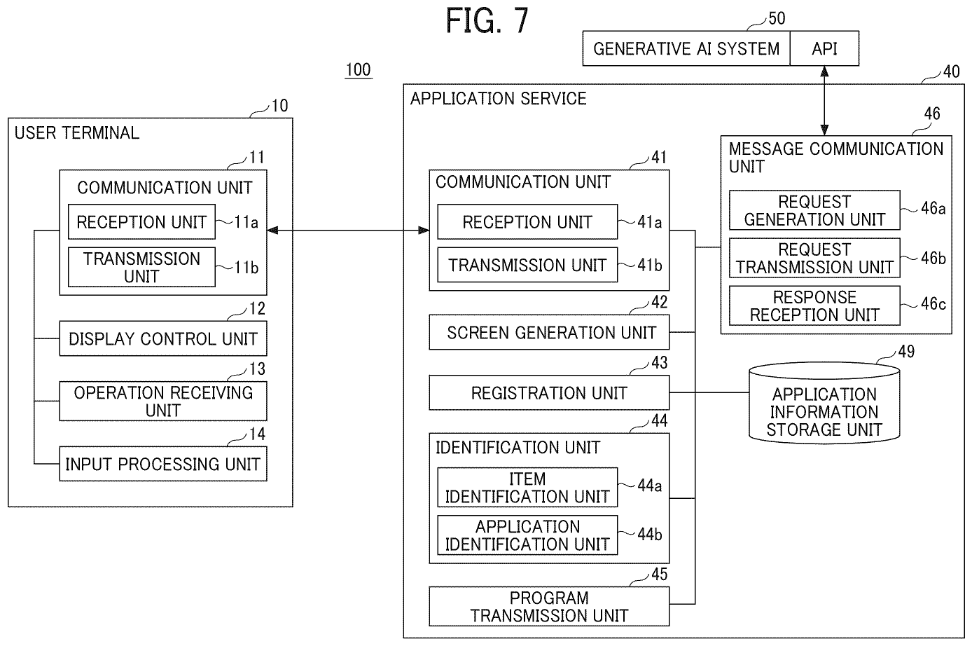

A functional configuration of the information processing system 100 will be described next with reference to FIG. 7. FIG. 7 is a diagram illustrating an example of the functional configuration of the application service 40 and the user terminal 10.

### User Terminal

The user terminal 10 includes a communication unit 11, a display control unit 12, an operation receiving unit 13, and an input processing unit 14. These functional units are functions or units that are implemented by the CPU 501 illustrated in FIG. 6 executing instructions included in one or more programs installed on the user terminal 10. For example, the communication unit 11, the display control unit 12, the operation receiving unit 13, and the input processing unit 14 may be implemented by a web browser and a web application. The web application is transmitted from the application service 40 to the user terminal 10. When the user terminal 10 executes a native application, the native application implements the communication unit 11, the display control unit 12, the operation receiving unit 13, and the input processing unit 14.

The communication unit 11 transmits and receives various types of information to and from the application service 40. The communication unit 11 includes a reception unit 11a and a transmission unit 11b. In the present embodiment, the reception unit 11a receives screen information of an input screen of an application or the like from the application service 40. The transmission unit 11b transmits, for example, previously input values of input items, designation of an input item for which a value is to be generated to the application service 40. The reception unit 11a receives a value to be set for the designated input item from the application service 40.

The display control unit 12 interprets screen information of various screens to display the screens on the display 506.

The operation receiving unit 13 receives various user operations on the various screens displayed on the display 506.

The input processing unit 14 inputs a value transmitted from the application service 40 and corresponding to the designated input item to the input field of the designated input item. The display control unit 12 performs control to display the screen in which values are set to the respective input items. The input processing unit 14 operates as a result of a program transmitted from the application service 40 being executed by the web browser.

### Application Service

The application service 40 includes a communication unit 41, a screen generation unit 42, a registration unit 43, an identification unit 44, a program transmission unit 45, a message communication unit 46, and an application information storage unit 49. These functional units of the application service 40 are functions or units implemented as a result of the CPU 501 illustrated in FIG. 6 executing instructions included in one or more programs installed on the application service 40. The application information storage unit 49 is implemented by, for example, the HD 504 or the RAM 503 illustrated in FIG. 6. The application information storage unit 49 is not necessarily included in the application service 40. In some embodiments, the application information storage unit 49 is on a network accessible from the application service 40.

The communication unit 41 transmits and receives various types of information to and from the user terminal 10. The communication unit 41 includes a reception unit 41a and a transmission unit 41b. The reception unit 41a receives, for example, the previously input values of the input items and designation of the input item for which a value is to be generated from the user terminal 10. The transmission unit 41b transmits the value of the designated input item to the user terminal 10. The transmission unit 41b transmits a web application to be executed by the user terminal 10 and screen information used by the web application for displaying screens to the user terminal 10.

The screen generation unit 42 generates the screen information of screens to be displayed by the user terminal 10. The screen information is a program written in, for example, Hyper Text Markup Language (HTML), JavaScript® Object Notation (JSON), Extensible Markup Language (XML), a script language, or a Cascading Style Sheet (CSS). The screen information may be referred to as a web application. The structure of the web page is specified by HTML, the operation of the web application is defined by the script language, and the style of the web page is specified by the CSS. The user terminal 10 may execute a native application. The native application is an application that becomes executable once the application is installed on the user terminal 10. In the case of the native application, the user terminal 10 holds the configuration of the screens, and information to be displayed is transmitted, for example, in a form of JSON or XML.

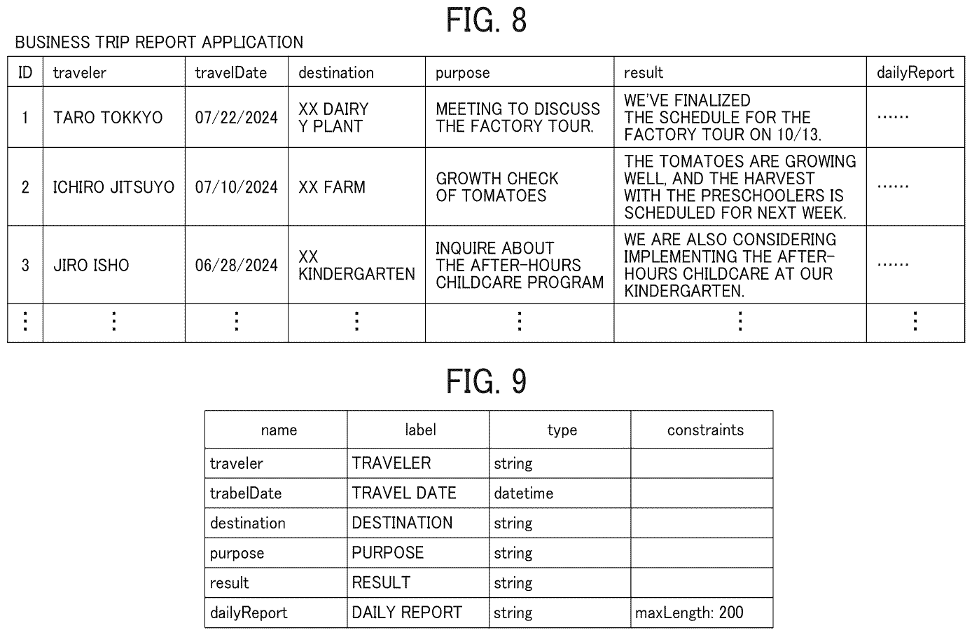

The registration unit 43 manages application information in the application information storage unit 49 on an application-by-application basis. The registration unit 43 registers a value corresponding to an input item transmitted from the user terminal 10 (or may be transmitted from the generative AI system 50) to the application information storage unit 49. The application information includes information set for the input items of the application and information related to the input items of the application. Thus, the application information storage unit 49 stores the information set for the input items of the application and the information related to the input items (see FIGS. 8 and 9).

The identification unit 44 includes an item identification unit 44a and an application identification unit 44b. Based on the information for identifying the application, which is received along with the request for AI-powered input, the item identification unit 44a identifies input items of the application. Based on the information for identifying the application selected by the user, the application identification unit 44b identifies the application name of the application.

In response to a request for a program transmitted from the user terminal 10, the program transmission unit 45 transmits the program to the user terminal 10. This program is a web application, and more specifically JavaScript®included in the web application, for example.

The message communication unit 46 transmits and receives a message to and from the generative AI system 50.

The API of the generative AI system 50 is made publicly available. The message communication unit 46 calls the API to transmit a request message including a chat message to the generative AI system 50. The message communication unit 46 receives a response message from the generative AI system 50. As described above, the request message is information including a chat message. The chat message may be referred to as a request message, which is commonly used in HTTP communication.

The message communication unit 46 includes a request generation unit 46a, a request transmission unit 46b, and a response reception unit 46c. The request generation unit 46a generates a request message for calling the API made publicly available by the generative AI system 50. The request message requests the generative AI system 50 to generate information. The request message may include a text portion, which is called a prompt, and image data, which may be the image data itself or a Uniform Resource Locator (URL) associated with the image data. The request message may further include audio data or the like.

The request transmission unit 46b transmits a request to the generative AI system 50. The request includes, along with the list of input items, the previously input values, the application name, and the input item for which a value is to be generated, an instruction to generate a value corresponding to the designated input item. This request is included in the request message generated by the request generation unit 46a.

The response reception unit 46c receives a response message generated by the generative AI system 50 in response to the instruction transmitted to the generative AI system 50. This response message includes the value corresponding to the designated input item.

### Application Information Storage Unit

FIG. 8 illustrates an example of information set for input items of an application out of application information. The information set for these input items includes information manually set by the user and information generated by the generative AI system 50. FIG. 8 illustrates the information set for the input items of the application by taking the business trip report application as an example. The information set for the input items is managed on a record-by-record basis. Each record is identified by an ID. In the case of the business trip report application, the information set for the input items is referred to as business trip information. The business trip information has values for “traveler”, “travelDate”, “destination”, “purpose”, “result”, and “dailyReport”. Note that the “traveler”, the “travelDate”, the “destination”, the “purpose”, the “result”, and the “dailyReport” correspond to the input items, and are the same as those listed in a name item in FIG. 9.

FIG. 9 is a diagram illustrating an example of the information related to the input items of the application out of the application information.

The information related to the input items defines what kind of information is to be stored for each of the input items.

The name item indicates identification information of each input item used by the application service 40 for management and identification of the input item.

A label item indicates a name (so-called label) of the input item displayed on the input screen 210 of the business trip report application.

A type item indicates the data format of the input item.

A constraints item defines constraints for the value of the input item. For example, a constraint that the maximum number of characters (maxLength) is 200 is set for the input item with the label item of “daily report”.

### Operations or Processes

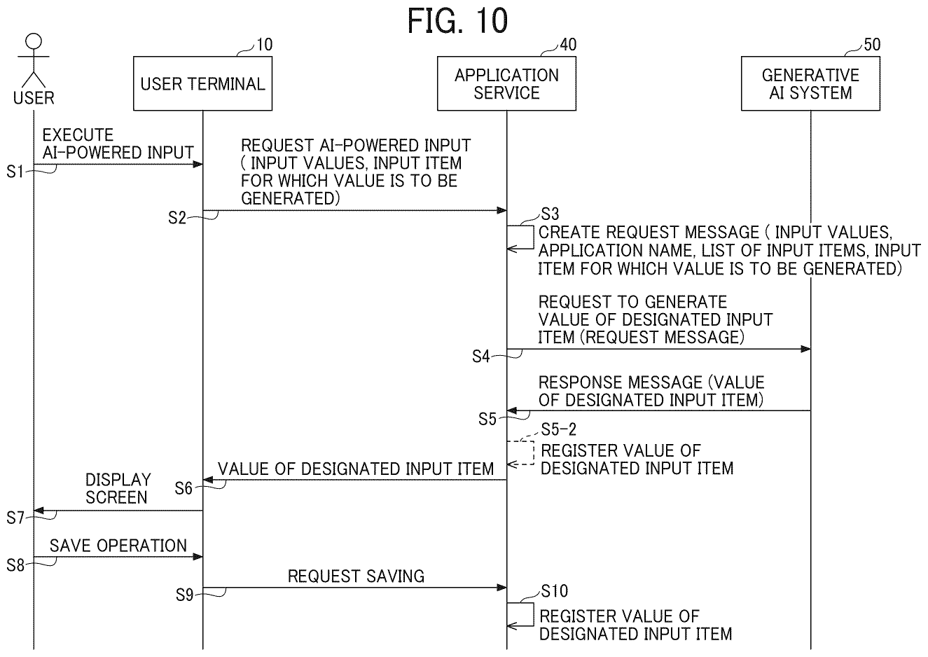

An overall procedure of a process performed by the information processing system 100 will be described with reference to FIG. 10. FIG. 10 is a sequence diagram for describing an example of the process performed by the information processing system 100. The business trip report application is already registered to the application service 40.
S1: The user terminal 10 displays the input screen 210 of the business trip report application. When the input screen 210 of the business trip report application is implemented by the web application, the transmission unit 11b transmits a request for one or more programs to be executed by the user terminal 10 to the application service 40. The program transmission unit 45 of the application service 40 transmits the web application to the user terminal 10. The web application includes a program. The program causes a process to be executed. The process includes displaying a screen that receives input of a value to an input field from a user and that can receive an instruction to generate information to be input to an input field of a designated input item from a list of input items and previously input values. The process includes, in response to receipt of the instruction on the screen, transmitting a request to the application service 40. The request includes an instruction to generate a value corresponding to the designated input item from the list of input items and the previously input values. The process includes receiving the value corresponding to the designated input item from the application service 40. The value is acquired in response to the application service 40 transmitting the request to the generative AI system 50. The process includes inputting (displaying) the received value to the input field of the designated input item. The process includes transmitting the value input in the input field, to the application service 40 to manage the value in the application service 40. That is, the “instruction to generate information to be input to an input field from a list of input items and previously input values” is an instruction to automatically input information to the input field.

The user inputs relatively-easy-to-input information such as the date on the input screen 210 of the business trip report application that is currently displayed. The user presses an “AI-powered input” button 228 for an input-assistance-desired input item such as the daily report field 216 to start AI-powered input. The operation receiving unit 13 of the user terminal 10 receives this operation. The AI-powered input refers to a processing sequence of requesting the generative AI system 50 to analyze application-related information to generate the value of the designated input item and transmit the value to the user terminal 10.
S2: In response to the operation of pressing the “AI-powered input” button 228, the transmission unit 11b of the user terminal 10 transmits identification information of the application, a record ID of the currently displayed record (information for identifying the record), previously input values of input items at the present point, and an input item for which a value is to be generated to the application service 40. The transmission unit 11b requests the application service 40 to provide AI-powered input along with the transmission of these pieces of information. The previously input values of the input items are values of the input items already having set values. In the present embodiment, the input item for which a value is to be generated is determined in advance. In other embodiments, an input item for which no value is set may be automatically selected. The circumstance is described in which the user terminal 10 holds the values input by the user for the input items to create the business trip report. Alternatively, the user terminal 10 may acquire the values from the application service 40. In this case, the user terminal 10 does not transmit the previously input values to the application service 40.

The previously input values may be omitted. The generative AI system 50 generates information that the generative AI system 50 has not learned. For example, the generative AI system 50 generates a value of the designated input item from at least one of the list of input items or the application name. When the transmission unit 11b does not transmit the previously input values, the use of few-shot prompting (described later) allows the generative AI system 50 to generate a more appropriate value of the input item. Alternatively, when the user inputs values for none of the input items, the application service 40 may switch the process to use the few-shot prompting.

At this time point, the application displayed by the user terminal 10 is identified. Thus, the identification information of the application is known. When a value is set to an application that is not displayed by the user terminal 10, the user selects the application, for example.

The record ID of the currently displayed record is identification information of the record currently displayed by the user terminal 10, and thus is known. When the currently displayed record is not registered to the application service 40, the record ID is yet to be assigned. Thus, the user terminal 10 notifies the application service 40 that the record ID is yet to be assigned. The application service 40 assigns a new record ID to the record.
S3: The reception unit 41a of the application service 40 receives the request for AI-powered input. The item identification unit 44a identifies, in the application information storage unit 49, information related to the input items of the application identified by the identification information of the application, and acquires the list of input items. More specifically, since the label items are appropriate for the input items used by the generative AI system 50, the item identification unit 44a receives a list of label items.

The application identification unit 44b acquires the application name of the application identified by the identification information of the application from the application information storage unit 49. The application name is requested because the analysis of the application name by the generative AI system 50 increases the accuracy of generating the appropriate value for the input item. Therefore, the application name may be omitted. The application service 40 may transmit the explanation note of the application to the generative AI system 50 instead of the application name. The explanation note of the application is that “This application assists in the creation of a business trip report”, for example.

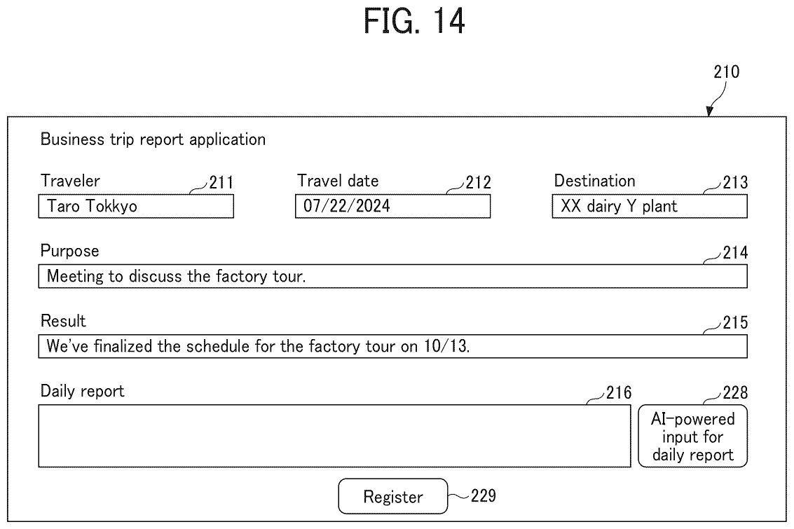

The request generation unit 46a of the application service 40 generates a request message using the application-related information (e.g., the list of input items, the previously input values, and the application name) and the input item for which a value is to be generated. This request message includes an instruction to generate information corresponding to the input item for which a value is to be generated. FIG. 11 illustrates a description example of this request message.
S4: The request transmission unit 46b transmits a request to generate a value of the designated input item to the generative AI system 50 together with this request message.
S5: The generative AI system 50 analyzes the list of input items, the previously input values, and the application name to generate the value of the designated input item. The generative AI system 50 transmits a response message (i.e., the value of the designated input item) to the application service 40.
S5-2: The response reception unit 46c of the application service 40 receives the response message (i.e., the value of the designated input item). Upon receipt of the response message, the registration unit 43 of the application service 40 may register the generated value to the application information storage unit 49. When the registration unit 43 registers the generated value to the application information storage unit 49, the following processing may be skipped. If the user corrects the generated value, the registered value may be overwritten with the corrected value. In the present embodiment, the case of registering the generated value for the input item in step S10, after the confirmation of the generated value by the user, will be described.
S6: The transmission unit 41b of the application service 40 transmits the value of the designated input item to the user terminal 10. The reception unit 11a of the user terminal 10 receives the value of the designated input item. The transmission unit 41b of the application service 40 may transmit screen information for updating the input screen 210 of the business trip report application to the user terminal 10, instead of transmitting the value of the designated input item alone.
S7: The input processing unit 14 of the user terminal 10 inputs the received value to the input field of the designated input item. The display control unit 12 displays the input screen 210 of the business trip report application in which the value is set for the designated input item.
S8: The user views the input screen 210 of the business trip report application to check the value of the input item generated by the generative AI system 50. The user edits the text (i.e., the generated value) on the input screen 210 if desired such as if the text has deficiencies. When saving the value of each input item in the input screen 210 of the business trip report application, the user performs a save operation (e.g. pressing a register button 229 (see FIG. 14)) on the user terminal 10. The operation receiving unit 13 receives the operation.
S9: The transmission unit 11b of the user terminal 10 designates the identification information of the application and the record ID, and transmits a save request to the application service 40 together with the values of the input items (i.e., the previously input values and the generated value). When the previously input values have been transmitted, the retransmission may be omitted.
S10: The reception unit 41a of the application service 40 receives the identification information of the application, the record ID, the save request, and the values of the input items. The registration unit 43 identifies the application based on the identification information of the application, and identifies the record based on the record ID. The registration unit 43 saves (registers) the values in association with the respective input items of the identified record in the application information storage unit 49. The transmission unit 41b of the application service 40 transmits “input OK” (which means registration of the values is completed) to the user terminal 10. The reception unit 11a of the user terminal 10 receives the “input OK”.
   Example of Request Message from Application Service to Generative AI System

FIG. 11 illustrates an example of parameters included in the request message transmitted by the application service 40 to the generative AI system 50 in step S4 in FIG. 10.

“messages” 241 is an API of the generative AI system 50 and indicates that the following is a chat message.

“role” 242 is an API of the generative AI system 50, and indicates a category of the source of the request message. The categories include “user” (indicating the user), “assistant” (indicating AI of the generative AI system 50), and “system” (indicating settings made by the AI assistant).

“content” 243 is an API of the generative AI system 50, and a dialog is set. Since the “content” has an array structure, a prompt and a plurality of pieces of image data may be set. In FIG. 11, three parameters 244 to 246 are written in the JSON format. Two of the three parameters 244 to 246 are files.

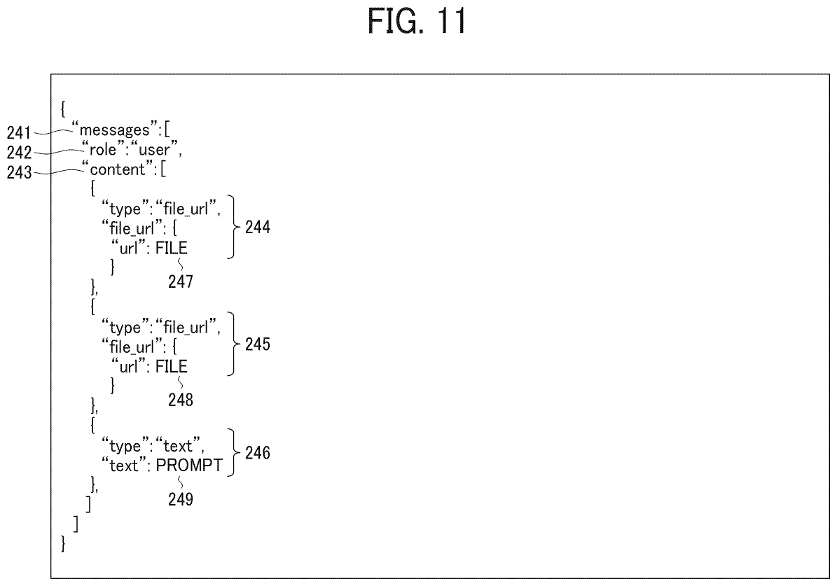

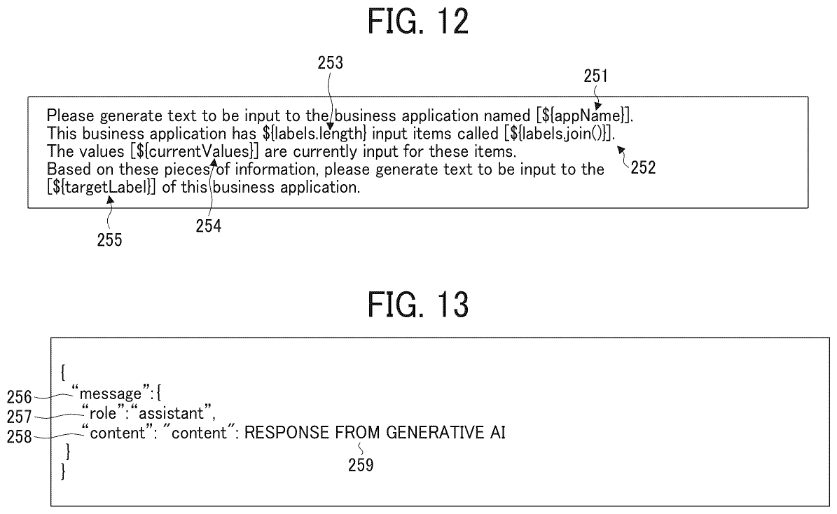

The parameters 244 to 246 represent the format of information transmitted to the generative AI system 50. “type” defines the data type. When the “type” is “text”, the value of the “text” is “prompt” 249. In the “prompt” 249, a prompt is set. FIG. 12 illustrates an example of a template of the prompt set in the “prompt” 249.

When the “type” is “file_url”, the value of the “file_url” is “file” 247 or 248. In the “file” 247 or 248, a URL where image data is stored or an image encoded by Base64 is input. When the application has one input item for image data, the parameters 244 and 245 may be reduced to one.

The request message including the prompt and the files as illustrated in FIG. 11 is transmitted to the generative AI system 50. In the present embodiment, the files may be omitted.

FIG. 12 is a diagram for describing the prompt set in the “prompt” 249 in FIG. 11. A character string illustrated in FIG. 12 is a template used by the request generation unit 46a to create the prompt. The character string includes five ${ . . . } expressions. When the request message is transmitted, the application-related information and the input item for which a value is to be generated are set in ${appName} 251, ${labels.join( )} 252, ${labels.length} 253, ${currentValues} 254, and ${targetLabel} 255. That is, the five ${ . . . } expressions are replaced with the application-related information and the input item for which a value is to be generated. The rest of the character string is fixed and is held by the request generation unit 46a in advance.

The application name is set in the ${appName} 251. In some embodiments, the application name may be omitted. In some embodiments, the explanation note of the application (for identifying the application) may be set.

The list of input items is set in the ${labels.join( )} 252.

The number of input items is set in the ${labels.length} 253.

The previously input values of the input items are set in the ${currentValues} 254.

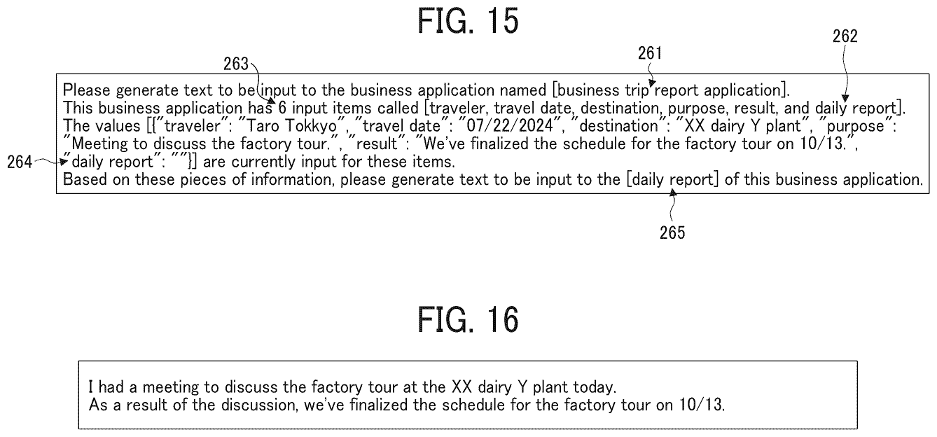

The input item for which generation of a value is desired (e.g., one of name items) is set in the ${targetLabel} 255. A specific setting example will be described with reference to FIG. 15.

Example of Response Message from Generative AI System to Application Service

FIG. 13 illustrates the format of the response message transmitted by the generative AI system 50 to the application service 40 in step S5 in FIG. 10. That is, FIG. 13 presents the format rather than the response message itself.

“messages” 256 indicates that the following is a response message.

“role” 257 indicates a category of a sender that transmits the response message. The sender is “assistant” (AI of the generative AI system 50) in this example.

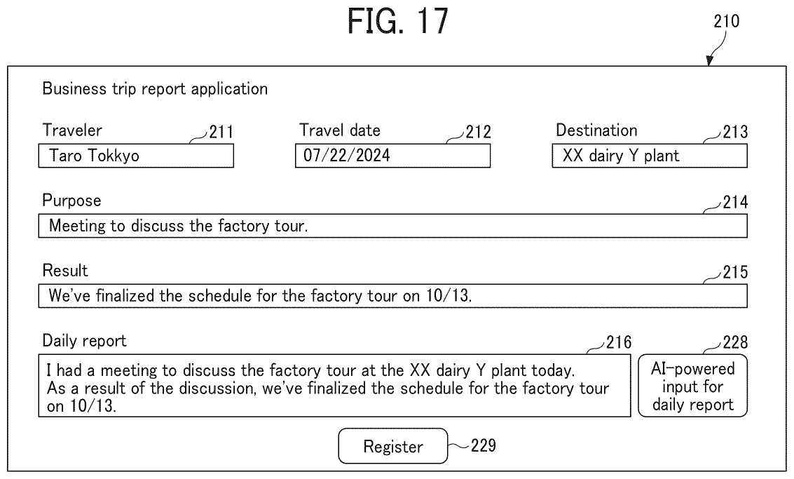

“content” 258 presents the content of the response message. In this example, the “content” 258 presents a response 259 (i.e., the input item and the value) from the generative AI system 50. The details of the response message from the generative AI system 50 will be described with reference to FIG. 16.

### Example of Setting Values for Input Items

An example of setting values for input items will be described below using the business trip report application and the preschool newsletter creation application as examples.

### Example of Setting Daily Report of Business Trip Report Application

With reference to FIG. 14 and other drawings, an example of setting a value to an input item of the business trip report application will be described. FIG. 14 illustrates an example of the input screen 210 of the business trip report application displayed by the user terminal 10. In the description of FIG. 14, differences from FIG. 2 will be described. The daily report field 216 in the input screen 210 of the business trip report application is a specific input field to receive input of text.

In FIG. 14, the user has input values to the traveler field 211, the travel date field 212, the destination field 213, the purpose field 214, and the result field 215. In this state, the user desires to generate the value to be input to the daily report field 216 using the generative AI system 50. Accordingly, the user presses the “AI-powered input” button 228. The daily report field 216 is an input field to which the user can manually input the value without using the generative AI system 50.

The “AI-powered input” button 228 is enabled (becomes pressable) when values are input to one or more predetermined input items among the input items of the business trip report application. The “AI-powered input” button 228 is a display component for receiving an instruction to generate text.

The application-related information for the business trip report application will be described. The application name of the business trip report application is “business trip report application”. According to the information related to the input items in FIG. 9, the list of input items (label items) includes the traveler, the travel date, the destination, the purpose, the result, and the daily report. Among these input items, those already having input values are the traveler, the travel date, the destination, the purpose, and the result. Thus, the input item for which generation of a value is desired is the daily report. In the present embodiment, generating a value of the “daily report” is determined in advance. The request generation unit 46a uses these pieces of information to set the application name, the list of input items, the previously input values of the input items, and the input item for which a value is to be generated in the prompt in FIG. 12.

FIG. 15 illustrates an example of the prompt generated by the request generation unit 46a. The following information is set in the ${appName} 251, the ${labels.join( )} 252, the $ {labels.length} 253, the ${currentValues} 254, and the ${targetLabel} 255 illustrated in FIG. 12.

In the ${appName} 251, “business trip report application” 261 is set.

In the ${labels.join( )} 252, “traveler, travel date, destination, purpose, result, and daily report” 262 are set. That is, the label items in the information related to the input items are set. The name items are not set because the name items serve as the identification information, and information irrelevant to the labels is often set for the name items.

In the ${labels.length} 253, “6” 263 is set.

In the ${currentValues} 254, [{“traveler”: “Taro Tokkyo”, “travel date”: “Jul. 22, 2024”, “destination”: “XX dairy Y plant”, “purpose”: “Meeting to discuss the factory tour.”, “result”: “We've finalized the schedule for the factory tour on October 13.”, “daily report”: “”}] 264 is set. That is, the input items already having set values are associated with the respective values. The input item having no set value such as the “daily report” is associated with a blank value (“”).

In the ${targetLabel} 255, “daily report” 265 is set. The input item set in the $ {targetLabel} 255 is determined in advance. Alternatively, the request generation unit 46a may determine the input item having no set value, and set this input item in the $ {targetLabel} 255. If there are two or more input items having no set value, the two or more input items may be set in the ${targetLabel} 255.

The generative AI system 50 grasps that the business trip report application is the target, from the “business trip report application” 261 at the beginning of the prompt. The generative AI system 50 then grasps the input items of the business trip report application, from the “traveler, travel date, destination, purpose, result, and daily report” 262. The generative AI system 50 then grasps the previously input values of the input items. The generative AI system 50 then grasps a request “to generate text to be input to the daily report”, and generates the text to be input to the “daily report” using the previously input values of the input items.

FIG. 16 illustrates an example of the response message from the generative AI system 50 in response to the request message including the prompt illustrated in FIG. 15. The generative AI system 50 analyzes the request message including the prompt illustrated in FIG. 15 and generates the value to be set to the “daily report”. An example of the text generated by the generative AI system 50 is “I had a meeting to discuss the factory tour at the XX dairy Y plant today. As a result of the discussion, we've finalized the schedule for the factory tour on October 13.”. Comparison of the generated text with the previously input values indicates that the response message includes the destination, the purpose, and the result.

The application service 40 uses the response message illustrated in FIG. 16 to transmit the value to be displayed in the business trip report application to the user terminal 10.

The response message may include the information for identifying the application selected by the user although the information is not included in the example in FIG. 16. The information for identifying the application may be, for example, the application name. The application identification unit 44b identifies the application, based on the information for identifying the application. The item identification unit 44a identifies the input items associated with this identified application (see FIG. 9).

FIG. 17 illustrates an example of the input screen 210 of the business trip report application in which the generated value is set in the daily report field 216 of the business trip report application. The input processing unit 14 inputs the values corresponding to the respective input items to the respective input fields of the input items. That is, the text generated by the generative AI system 50 and illustrated in FIG. 16 is set in the daily report field 216.

The user can manually edit the value generated by the generative AI system 50 and input for the input item by the input processing unit 14. The user can register the value (text) set for the input item to the business trip report application by pressing the register button 229 on the input screen 210 of the business trip report application.

As described above, the user inputs values for input items that are stylized and thus relatively easy to input the values among the input items of the business trip report application, so that a value can be automatically set for a predetermined input item which takes time to input. The user terminal 10 can set an appropriate value for an input item of any application other than the business trip report application.

The user may input the value to the daily report field 216, and request the application service 40 to generate the values to be input to the traveler field 211, the travel date field 212, the destination field 213, the purpose field 214, and the result field 215. In this case, if the daily report field 216 includes information on the traveler, the travel date, the destination, the purpose, and the result, it is expected that appropriate values are generated for the respective input items. In this case, the traveler field 211, the travel date field 212, the destination field 213, the purpose field 214, and the result field 215 are each a specific input field to receive input of text.

### Example of Setting Newsletter Text of Preschool Newsletter Creation Application

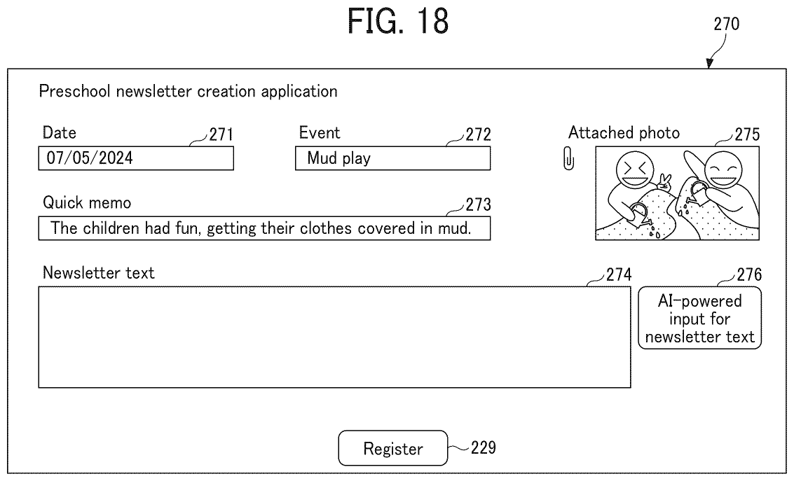

With reference to FIG. 18 and other drawings, an example of setting a value to an input item of the preschool newsletter creation application will be described. FIG. 18 illustrates an example of an input screen 270 of the preschool newsletter creation application displayed by the user terminal 10. The preschool newsletter creation application includes a date field 271, an event field 272, a quick memo field 273, a newsletter text field 274, an attached photo field 275, and an “AI-powered input” button 276. The components other than the “AI-powered input” button 276 are input items. In the input screen 270 of the preschool newsletter creation application, the newsletter text field 274 is a specific input field to receive input of text.

Users can use the preschool newsletter creation application for their work or personally. For example, staff members at the preschool use the preschool newsletter creation application to create the preschool newsletter to be sent to parents. This facilitates the creation of the preschool newsletter to be sent to parents.

For example, to set a value to the newsletter text field 274 using the generative AI system 50, the user inputs information to the date field 271, the event field 272, the quick memo field 273, and the attached photo field 275. The attached photo field 275 displays a thumbnail of image data of a photo of preschoolers. In this state, the user desires to generate the value to be input to the newsletter text field 274 using the generative AI system 50. Accordingly, the user presses the “AI-powered input” button 276. The “AI-powered input” button 276 is enabled (becomes pressable) when values are input to one or more predetermined input items among the input items of the preschool newsletter creation application.

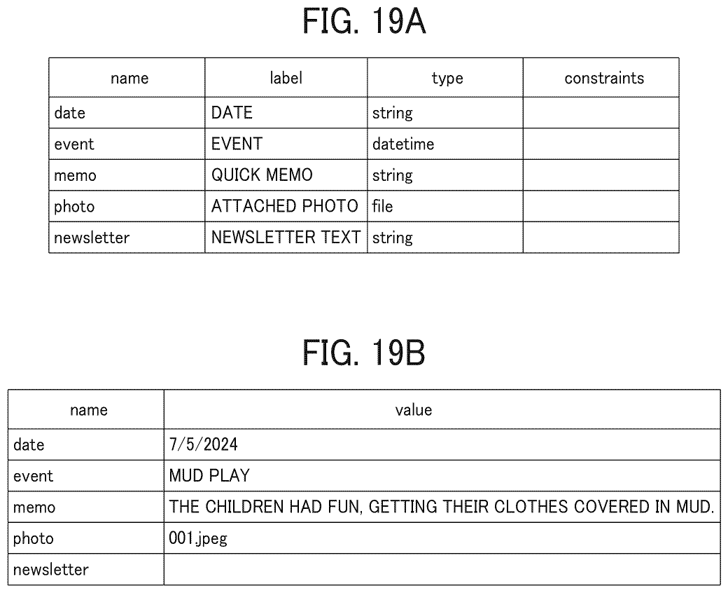

FIG. 19A illustrates an example of information related to input items of the preschool newsletter creation application. Similarly to the information related to the input items of the business trip report application (FIG. 9), the information related to the input item of the preschool newsletter creation application includes a name item, a label item, a type item, and a constraints item. These items may be substantially the same as those illustrated in FIG. 9.

FIG. 19B illustrates an example of information set for the input items of the preschool newsletter creation application. FIG. 19B illustrates information of one record. In the case of the preschool newsletter creation application, information of one record set for the input items is referred to as preschool newsletter information. The preschool newsletter information is represented by the name item and the value item associated with each other. The name item (e.g., date, event, memo, photo, or newsletter) is identification information of an input item, and the value item is a value of the input item.

The application-related information for the preschool newsletter creation application will be described. The application name of the preschool newsletter creation application is “preschool newsletter creation application”. According to the information related to the input items in FIG. 19A, the labels of the input items are date, event, quick memo, attached photo, and newsletter text. Thus, the number of input items is five. Among these input items, those already having input values are the date, the event, the quick memo, and the attached photo. The input item for which generation of a value is desired is the newsletter text. The request generation unit 46a uses these pieces of information to set the application name, the list of input items, the previously input values of the input items, and the input item for which a value is to be generated in the prompt in FIG. 12. Since the image data set in the attached photo is a file, the image data set in the attached photo is set in the parameter 244 illustrated in FIG. 11.

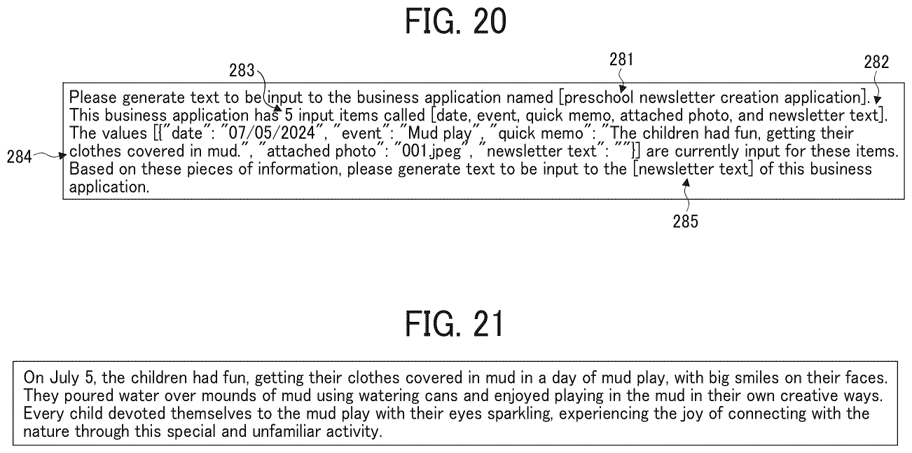

FIG. 20 illustrates an example of the prompt generated by the request generation unit 46a. The following information is set in the ${appName} 251, the ${labels.join( )} 252, the $ {labels.length} 253, the ${currentValues} 254, and the ${targetLabel} 255 illustrated in FIG. 12.

In the ${appName} 251, “preschool newsletter creation application” 281 is set.

In the ${labels.join( )} 252, “date, event, quick memo, attached photo, and newsletter text” 282 is set. That is, the label items in the information related to the input items are set. The name items are not set because the name items serve as the identification information, and information irrelevant to the labels is often set for the name items.

In the ${labels.length} 253, “5” 283 is set.

In the ${currentValues} 254, [{“date”: “Jul. 5, 2024”, “event”: “Mud play”, “quick memo”: “The children had fun, getting their clothes covered in mud.”, “attached photo”: “001.jpeg”, “newsletter text”: “”}] 284 is set. That is, the input items already having set values are associated with the respective values. The input item having no set value such as the “newsletter text” is associated with a blank value (“”).

The file name is set for the attached photo. However, the generative AI system 50 may skip analyzing the image data in the attached photo to generate the “newsletter text”. Accordingly, the prompt illustrated in FIG. 20 preferably includes a sentence such as “Please generate text to be input to the ”newsletter text“ by recognizing the image of 001.jpeg”. Since the generative AI system 50 has the ability to generate text data from the contents included in the image data, the above sentence enables reflection of the image data in the “newsletter text”.

In the ${targetLabel} 255, “newsletter text” 285 is set. The input item set in the $ {targetLabel} 255 is determined in advance. Alternatively, the request generation unit 46a may determine the input item having no set value, and set this input item in the $ {targetLabel} 255. If there are two or more input items having no set value, the two or more input items may be set in the ${targetLabel} 255.

The generative AI system 50 grasps that the preschool newsletter creation application is the target, from the “preschool newsletter creation application” 281 at the beginning of the prompt. The generative AI system 50 then grasps the input items of the preschool newsletter creation application, from the “date, event, quick memo, attached photo, and newsletter text” 282. The generative AI system 50 then grasps the previously input values of the input items. The generative AI system 50 then grasps a request “to generate text to be input to the newsletter text”, and generates text to be input to the “newsletter text” using the previously input values of the input items.

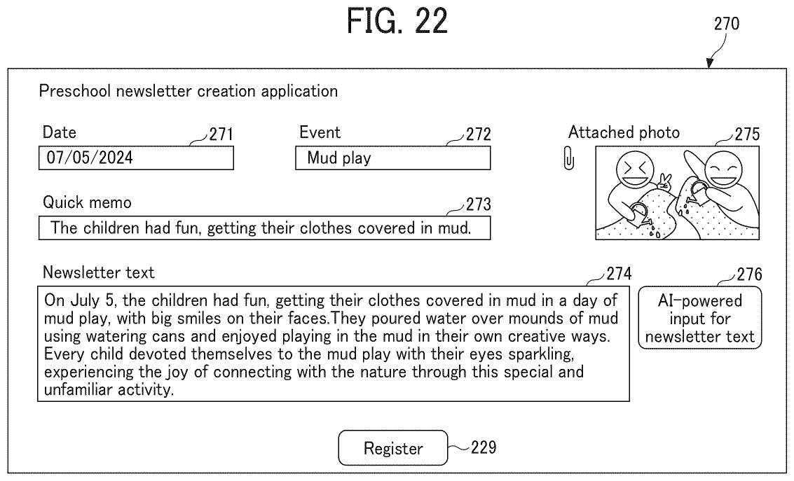

FIG. 21 illustrates an example of the response message from the generative AI system 50 in response to the request message including the prompt illustrated in FIG. 20. The generative AI system 50 analyzes the request message including the prompt illustrated in FIG. 20 and generates the value to be set to the “newsletter text”. An example of the text generated by the generative AI system 50 is “On July 5, the children had fun, getting their clothes covered in mud in a day of mud play, with big smiles on their faces. They poured water over mounds of mud using watering cans and enjoyed playing in the mud in their own creative ways. Every child devoted themselves to the mud play with their eyes sparkling, experiencing the joy of connecting with the nature through this special and unfamiliar activity.” Comparison of the generated text with the previously input values indicates that the response message includes the date, the event, and the quick memo.

The application service 40 uses the response message illustrated in FIG. 20 to transmit the value (text) to be set in the newsletter text field 274 of the preschool newsletter creation application to the user terminal 10.

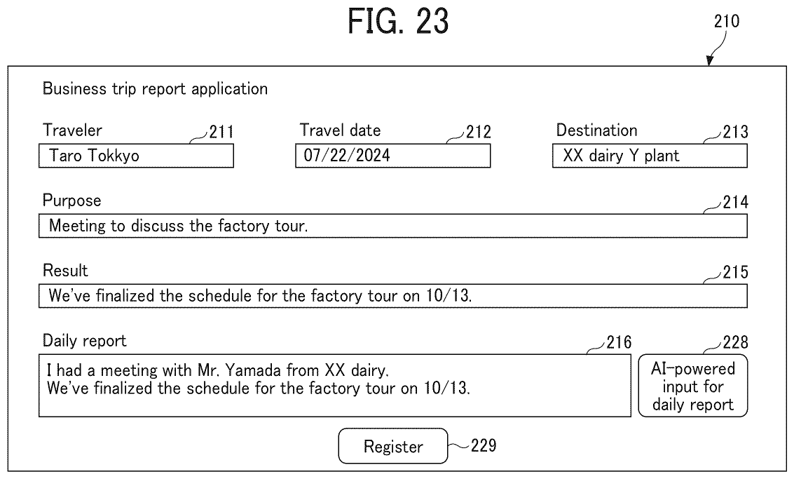

FIG. 22 illustrates an example of the input screen 270 of the preschool newsletter creation application in which the generated value is set in the newsletter text field 274 of the preschool newsletter creation application. The input processing unit 14 inputs the values corresponding to the respective input items to the respective input fields of the input items. That is, the text generated by the generative AI system 50 and illustrated in FIG. 21 is set in the newsletter text field 274.

The user can manually edit the value generated by the generative AI system 50 and input for the input item by the input processing unit 14. The user can register the content set for the input item to the preschool newsletter creation application by pressing the register button 229 on the input screen 270 of the preschool newsletter creation application.

As described above, the user inputs values for input items that are stylized and thus relatively easy to input the values among the input items of the preschool newsletter creation application, so that a value can be automatically set for a predetermined input item which takes time to input. The user can set an appropriate value for an input item of any application other than the preschool newsletter creation application.

The user may input the values to the newsletter text field 274 and the attached photo field 275, and request the generative AI system 50 to generate the values to be input to the date field 271, the event field 272, and the quick memo field 273. In this case, if the newsletter text field 274 or the attached photo field 275 includes information on the date, the event, and the quick memo, it is expected that appropriate values are generated for the respective input items. In this case, the date field 271, the event field 272, and the quick memo field 273 are each a specific input field to receive input of text.

With the information processing system 100 according to the present embodiment, in response to the user inputting values for one or more input items, the generative AI system 50 generates a value of an input item having no set value, and the generated value is automatically set for the input item. The user can set an appropriate value for an input item of any applications other than a single application.

### Second Embodiment

In a second embodiment, modifications applicable to the first embodiment will be described. In the present embodiment, the description will be given assuming that the hardware configuration diagram in FIG. 6 and the functional block diagram in FIG. 7 described in the first embodiment can also be used.

When Value Exists for Input Item for which Value is to Be Generated

In the first embodiment, the description is given such that the input item for which a value is to be generated is determined in advance or the input item having no set value is automatically determined. When the input item for which a value is to be generated is determined in advance as in the former case, a value is already set for the input item in some cases. In this case, the user terminal 10 transmits the existing value as a draft to the application service 40. The application service 40 transmits the existing value to the generative AI system 50. This can make the text generated by the generative AI system 50 closer to the text intended by the user.

A case where the generative AI system 50 generates the text of the daily report field 216 when text is previously input to the daily report field 216 will be described below using the business trip report application as an example.

FIG. 23 illustrates an example of the input screen 210 of the business trip report application displayed by the user terminal 10. In the description of FIG. 23, differences from FIG. 14 will be described. In FIG. 23, the user inputs values to the traveler field 211, the travel date field 212, the destination field 213, the purpose field 214, the result field 215, and the daily report field 216. In this state, the user desires to revise the text set to the daily report field 216. Accordingly, the user presses the “AI-powered input” button 228.

In the present embodiment, it is determined by the request generation unit 46a in advance that the value of the daily report field 216 is to be generated. As in the first embodiment, the request generation unit 46a generates a prompt including the application-related information and the designation of the input item for which a value is to be generated.

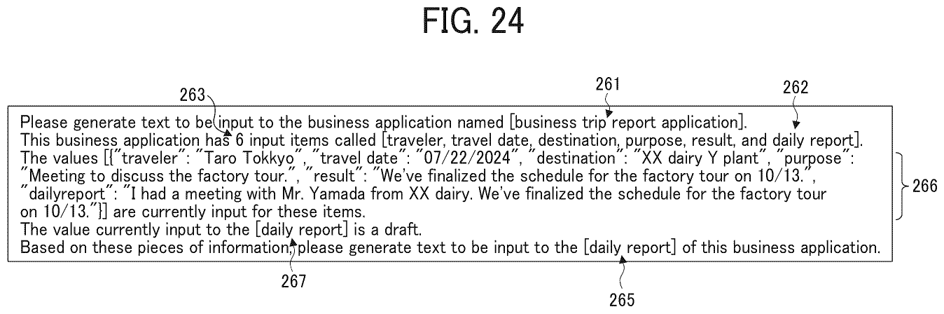

FIG. 24 illustrates an example of the prompt generated by the request generation unit 46a. In FIG. 24, differences from FIG. 15 will be described. In FIG. 24, information set in the ${currentValues} 254 differs from that in FIG. 15.

In the ${currentValues} 254, [{“traveler”: “Taro Tokkyo”, “travel date”: “Jul. 22, 2024”, “destination”: “XX dairy Y plant”, “purpose”: “Meeting to discuss the factory tour.”, “result”: “We've finalized the schedule for the factory tour on October 13.”, “daily report”: “I had a meeting with Mr. Yamada from XX Dairy. We've finalized the schedule for the factory tour on October 13.”}] 266 is set. That is, a draft 268 “I had a meeting with Mr. Yamada from XX Dairy. We've finalized the schedule for the factory tour on October 13.” is added in association with the “daily report”.

Text data 267 “The value currently input to the “daily report” is a draft.” is added to the prompt illustrated in FIG. 24. When the request generation unit 46a determines that the daily report field 216 is not blank, the request generation unit 46a adds the text input in the daily report field 216 to the prompt as the text data 267.

The generative AI system 50 determines, from the text data 267, the draft 268 to be a reference for the value to be generated for the daily report field 216, and uses the draft 268 in generation of the value. Thus, the generative AI system 50 is more likely to generate the text intended by the user. In this case, the input processing unit 14 overwrites the draft initially input in the daily report field 216, and the text generated by the generative AI system 50 is input to the daily report field 216.

The present embodiment provides the effects of the first embodiment. In addition, the application service 40 notifies the generative AI system 50 of the draft to the input item for which a value is to be generated. This facilitates the generation of the text intended by the user.

### Additional Instruction for Generation of Value

The information processing system 100 according to the present embodiment allows the generative AI system 50 to generate the value of the input item without the input of the prompt by the user. However, the user can input the prompt. This can bring the value generated for the input item by the generative AI system 50 closer to the text intended by the user.

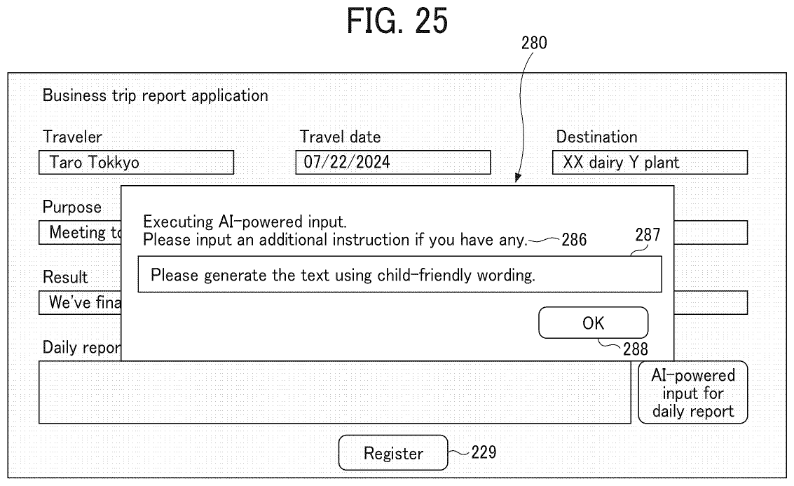

FIG. 25 illustrates an example of a prompt input screen 280 displayed as a pop-up window over the input screen 210 of the business trip report application. The prompt input screen 280 is displayed in response to the user pressing the “AI-powered input” button 228.

The prompt input screen 280 includes a message 286 “Executing AI-powered input. Please input an additional instruction if you have any.” and a prompt input field 287. If the user has an instruction to be given to the generative AI system 50 via the application service 40 in terms of the value to be input to the daily report field 216, the user can input the instruction to the prompt input field 287. In FIG. 25, an instruction “Please generate the text using child-friendly wording” is input. This instruction is a part of the prompt included in the request message. In response to the user pressing an OK button 288, the request message is generated.

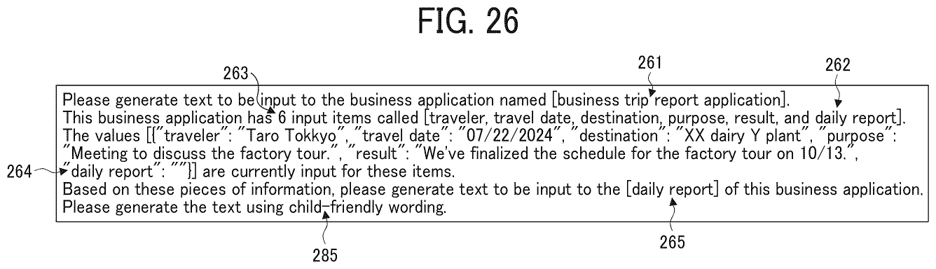

FIG. 26 illustrates an example of the prompt in the request message generated by the request generation unit 46a. In FIG. 26, differences from FIG. 15 will be described. The request message illustrated in FIG. 26 additionally includes text data 285 “Please generate the text using child-friendly wording”. When the instruction is input to the prompt input field 287, the request generation unit 46a adds the instruction to the prompt as the text data 285.

The generative AI system 50 generates the value to be set to the daily report field 216 with reference to the text data 285. This facilitates the generation of the text intended by the user.

The present embodiment provides the effects of the first embodiment. In addition, the user inputs the instruction to be used by the generative AI system 50 to generate the value. This facilitates the generation of the value (text) intended by the user.

### Confirmation Dialog and Re-generation

The user may be unsatisfied with the text generated by the generative AI system 50 and desire to generate the text again. To cope with such a circumstance, it is effective to display a confirmation dialog before the user terminal 10 sets the value generated by the generative AI system 50 to the application service 40 to allow the user to confirm the text generated by the generative AI system 50. This allows the user to repeat the generation until the text desired by the user is generated.

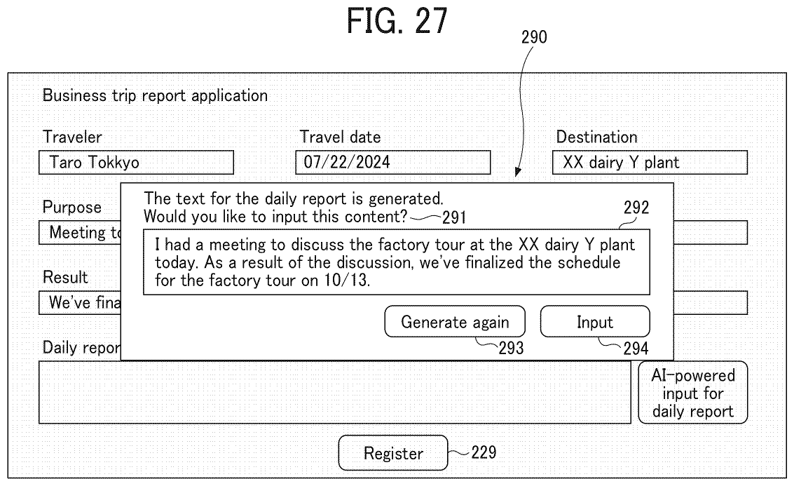

FIG. 27 illustrates an example of a confirmation dialog 290 displayed as a pop-up window over the input screen 210 of the business trip report application. The confirmation dialog 290 is displayed immediately after step S9 (before the value is set to the input field) in the sequence diagram in FIG. 10.

The confirmation dialog 290 includes a message 291 “The text for the daily report is generated. Would you like to input this content?”, a generated text display field 292, a generate again button 293, and a permit input button 294. The generated text display field 292 displays the text generated by the generative AI system 50. When the user is not satisfied with the text generated by the generative AI system 50, the user presses the generate again button 293.

This causes re-execution of step S2 and subsequent steps in the sequence diagram in FIG. 10, which allows the generative AI system 50 to generate the text to be input to the daily report field 216 again. The user can repeat the generation until the desired text is generated.

When step S2 and subsequent steps are executed again, the request generation unit 46a may include, in the prompt, the text generated immediately before and the text generated in the past and an instruction to generate text different from these texts. Thus, it is expected that the generative AI system 50 generates different text at each generation of text. When the user presses the generate again button 293, the user terminal 10 preferably displays the prompt input screen 280 illustrated in FIG. 25. This allows the user to designate how the user desires to improve the text generated by the generative AI system 50 each time.

The present embodiment provides the effects of the first embodiment. In addition, since re-generation is permitted, the generation can be repeated until the text desired by the user is generated.

### Instruction About Reference Form

In the first embodiment, the request generation unit 46a includes all the values previously input for the input items in the prompt. Alternatively, the user may select the values of the input items transmitted to the generative AI system 50 by the request generation unit 46a. This is because the values previously input for the input items by the user may include information serving as noise for the input item for which generation of the value is desired. Thus, allowing the user to select the values of the input items transmitted to the generative AI system 50 by the request generation unit 46a can eliminate the information serving as noise when the value is generated from the prompt transmitted to the generative AI system 50. This makes it easier for the generative AI system 50 to generate the text intended by the user.

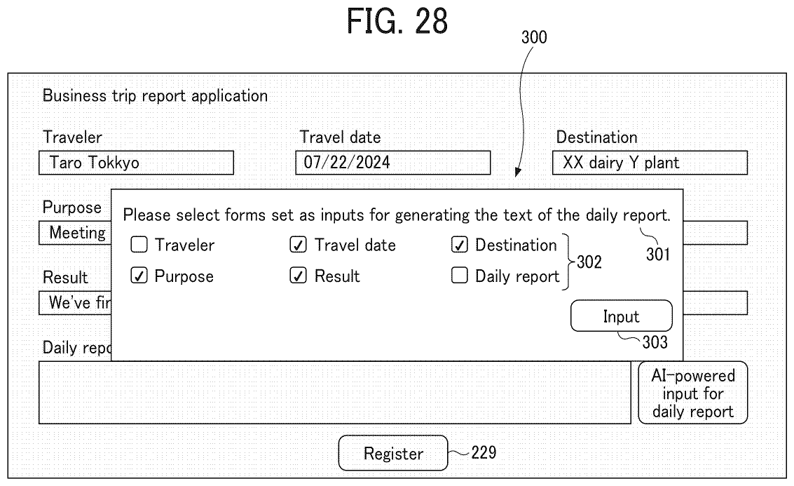

FIG. 28 illustrates an example of an input item selection dialog 300 displayed as a pop-up window over the input screen 210 of the business trip report application. The input item selection dialog 300 is displayed in response to the user pressing the “AI-powered input” button 228.

The input item selection dialog 300 includes a message 301 “Please select forms set as inputs for generating the text of the daily report.”, an option list 302, and an input button 303. The option list 302 displays the labels of the input items of the input screen 210 of the business trip report application. The labels are provided with respective checkboxes, which allow the user to select the input items that the user desires to transmit the previously input values to the generative AI system 50. In response to the user pressing the input button 303, the request generation unit 46a generates the request message using the values of the checked input items.

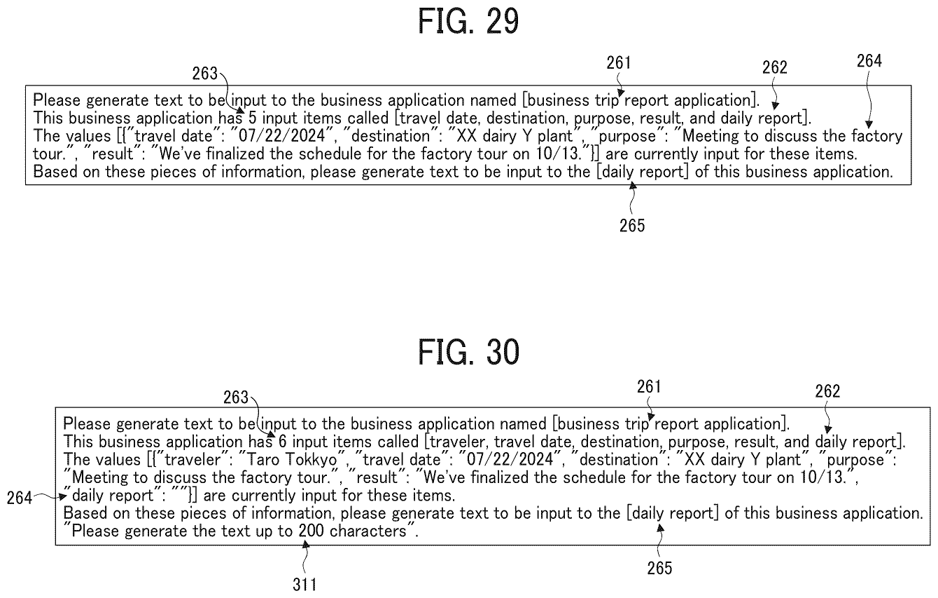

FIG. 29 illustrates an example of the prompt generated by the request generation unit 46a. In FIG. 29, differences from FIG. 15 will be described. In the request message illustrated in FIG. 29, the following information is set in the ${appName} 251, the ${labels.join( )} 252, the ${labels.length} 253, the ${currentValues} 254, and the ${targetLabel} 255 illustrated in FIG. 12.

In the ${appName} 251, “business trip report application” 261 is set.

In the ${labels.join( )} 252, “travel date, destination, purpose, result, and daily report” 262 is set. That is, the “traveler” is omitted. This is because the “traveler” is not selected in the option list 302. However, the “daily report” that is not selected in the option list 302 as well is present because the “daily report” is the input item for which the value is to be generated and the generative AI system 50 is preferably notified of the presence of the input item “daily report”.

In the ${labels.length} 253, “5” 263 is set. That is, the value is reduced by one since the “traveler” is omitted.

In the ${currentValues} 254, [{“travel date”: “Jul. 22, 2024”, “destination”: “XX dairy Y plant”, “purpose”: “Meeting to discuss the factory tour.”, “result”: “We've finalized the schedule for the factory tour on October 13.”}] 264 is set. That is, the “traveler” and the value thereof and the “daily report” and the value thereof (blank) are omitted. The “traveler” and the value thereof are omitted because the “traveler” is not selected in the option list 302. The “daily report” and the value thereof (blank) are omitted from the ${currentValues} 254 because the generative AI system 50 has been notified of the presence of the input item “daily report” in the “travel date, destination, purpose, result, and daily report” 262.

The ${targetLabel} 255 may be substantially the same as that illustrated in FIG. 15.

As described above, the prompt does not include the name of the traveler. Since the “daily report” rarely contains the name of the traveler, the information on the “traveler” may serve as noise in the generation of the value of the “daily report”. In the present embodiment, since the user selects not to transmit the value of the “traveler” to the generative AI system 50 via the application service 40, the value of the “traveler” that may serve as noise in the generation of the value is successfully excluded from the prompt transmitted to the generative AI system 50. This makes it easier for the generative AI system 50 to generate the text intended by the user.

The present embodiment provides the effects of the first embodiment. In addition, the user selects previously input values to be transmitted to the generative AI system 50. This facilitates the generation of the text intended by the user.

Request Message with Designated Input Range of Value

Some input items of the application may have an input range. For example, an input item with the data format of the character string may have the maximum number of characters and the minimum number of characters. An input item with the data format of the numerical value may have the maximum value and the minimum value.

In the information related to the input items illustrated in FIG. 9, the constraints item defines the constraint for the value of the input item. For example, a constraint (input range) that the maximum number of characters (maxLength) is 200 is set for the input item with the label item “daily report”.

The request generation unit 46a generates the prompt to which the information of the input range is added, and transmits the prompt additionally including the information on the input range to the generative AI system 50. This can prevent the value generated by the generative AI system 50 from being outside the input range of the application.

FIG. 30 illustrates an example of the prompt generated by the request generation unit 46a. In FIG. 30, differences from FIG. 15 will be described. The prompt illustrated in FIG. 30 additionally includes text data 311 “Please generate the text up to 200 characters.” In the text data 311, “200” is changed based on the constraints item in the information related to the input items illustrated in FIG. 9.

That is, as indicated below, ${ . . . } for the maximum number of characters is additionally set in the character string illustrated in FIG. 12.

“Please generate the text up to ${maxLength} characters”.

The request generation unit 46a replaces the ${maxLength} with “200”. Thus, the text data 311 other than “200” is fixed.

The generative AI system 50 analyzes the text data 311 of the request message, and generates the value of the “daily report” so that the value is not outside the input range.

The present embodiment provides the effects of the first embodiment. In addition, designation of the input range allows the generative AI system 50 to generate the value that is not outside the input range.

### Generation of Values of Plurality of Forms

The request generation unit 46a can request the generative AI system 50 to generate values for a plurality of input items with a single request message. This can speed up the processing compared to the case where the request generation unit 46a generates a plurality of request messages and requests the generative AI system 50 to generate a value for an input item each time. This reduces the number of calls of the generative AI system 50, and thus can reduce the use fee of the generative AI system 50.

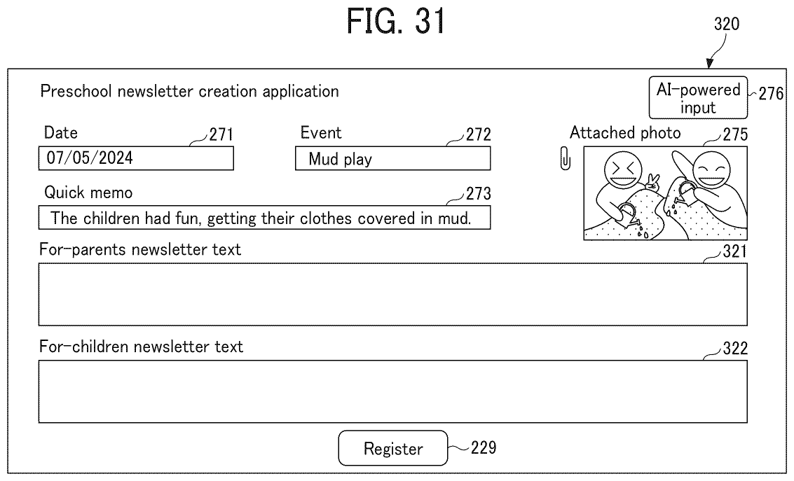

FIG. 31 illustrates an example of an input screen 320 of the preschool newsletter creation application displayed by the user terminal 10.

In the description of FIG. 31, differences from FIG. 18 will be described. The date field 271, the event field 272, the quick memo field 273, the attached photo field 275, and the “AI-powered input” button 276 are the same as those in FIG. 18. The input screen 320 of the preschool newsletter creation application illustrated in FIG. 31 further includes a for-parents newsletter input field 321 and a for-children newsletter input field 322. In response to the user pressing the “AI-powered input” button 276, a generation target selection dialog 330 is displayed.

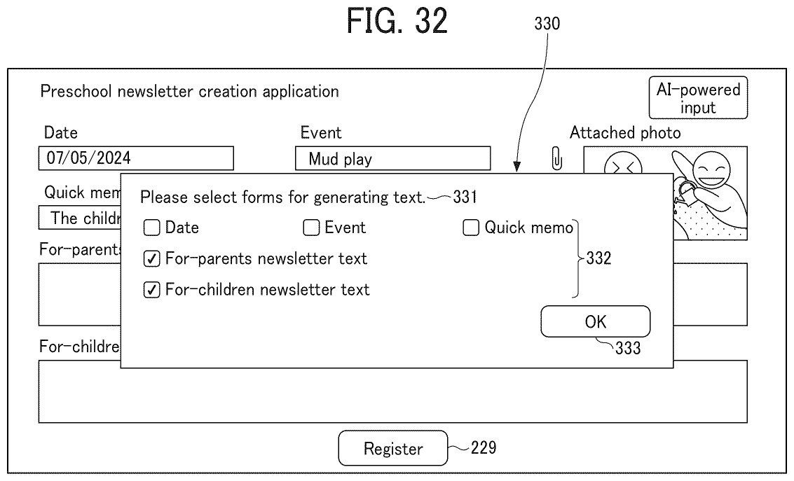

FIG. 32 illustrates an example of the generation target selection dialog 330 displayed as a pop-up window over the input screen 320 of the preschool newsletter creation application. The generation target selection dialog 330 includes a message 331 “Please select forms for generating text.”, an option list 332, and an OK button 333. The option list 332 displays the labels of the input items included in the input screen 320 of the preschool newsletter creation application. The labels are provided with respective checkboxes, which allow the user to select the input items that the user desires the generative AI system 50 to generate the values. In response to the user pressing the OK button 333, the request generation unit 46a generates the request message.

In FIG. 32, the input items for which values are to be generated are selected in response to pressing of the “AI-powered input” button 276. Alternatively, the input items for which values are to be generated may be determined in advance. Alternatively, the user may select the input items for which values are to be generated on a setting screen in advance.

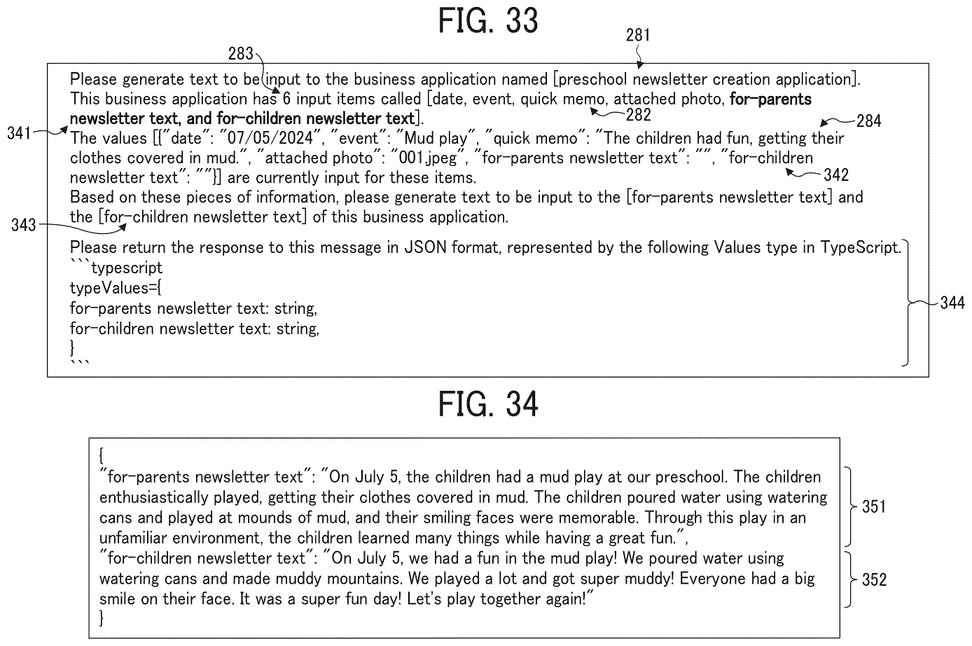

FIG. 33 illustrates an example of the prompt generated by the request generation unit 46a. In the description of FIG. 33, differences from FIG. 20 will be described. In the prompt illustrated in FIG. 33, the following information is set in the ${appName} 251, the $ {labels.join( )} 252, the ${labels.length} 253, the ${currentValues} 254, and the $ {targetLabel} 255 illustrated in FIG. 12.

The ${appName} 251 is substantially the same as that in FIG. 20.

In the ${labels.join( )} 252, “date, event, quick memo, attached photo, for-parents newsletter text, and for-children newsletter text” 282 is set. A portion “for-parents newsletter text, for-children newsletter text” 341 notifies the generative AI system 50 of the presence of the for-parents newsletter input field 321 and the for-children newsletter input field 322 in the preschool newsletter creation application.

In the ${labels.length} 253, “6” 283 is set.

In the ${currentValues} 254, [{“date”: “Jul. 5, 2024”, “event”: “Mud play”, “quick memo”: “The children had fun, getting their clothes covered in mud.”, “attached photo”: “001.jpeg”, “for-parents newsletter text”: “”, “for-children newsletter text”: “”}] 284 is set. A portion [“for-parents newsletter text”: “”, “for-children newsletter text”: “”] 342 notifies the generative AI system 50 of the value (blank) of the for-parents newsletter input field 321 and the value (blank) of the for-children newsletter input field 322.

In the ${targetLabel} 255, [“for-parents newsletter text” and “for-children newsletter text”] 343 is set. That is, the ${targetLabel} 255 instructs the generative AI system 50 to generate texts to be set to the for-parents newsletter input field 321 and the for-children newsletter input field 322.

The prompt illustrated in FIG. 33 includes a format designation 344. Since the generative AI system 50 generates a plurality of texts in response to the prompt illustrated in FIG. 33, a plurality of response messages may be generated. Thus, the format designation 344 instructs the generative AI system 50 to generate the values in the JSON format. Thus, a response message having a clear correspondence between the input item and the generated text is expected.

FIG. 34 illustrates an example of the response message from the generative AI system 50 in response to the request message including the prompt illustrated in FIG. 33. The response message includes “for-parents newsletter text” 351 and “for-children newsletter text” 352 in the JSON format. That is, the generative AI system 50 analyzes the request message including the prompt illustrated in FIG. 33 and generates the “for-parents newsletter text” 351 and the “for-children newsletter text” 352.

Comparison of the “for-parents newsletter text” 351 and the “for-children newsletter text” 352 with the previously input values of the “date”, “event”, and “quick memo” indicates that the “for-parents newsletter text” 351 and the “for-children newsletter text” 352 each include the date, the event, and the quick memo. The two texts are different from each other even when the previously input values referred to by the generative AI system 50 are the same. This is an effect of the portion [“for-parents newsletter text” and “for-children newsletter text”] 343.

The application service 40 uses the response message illustrated in FIG. 34 to transmit the values to be displayed by the preschool newsletter creation application to the user terminal 10.

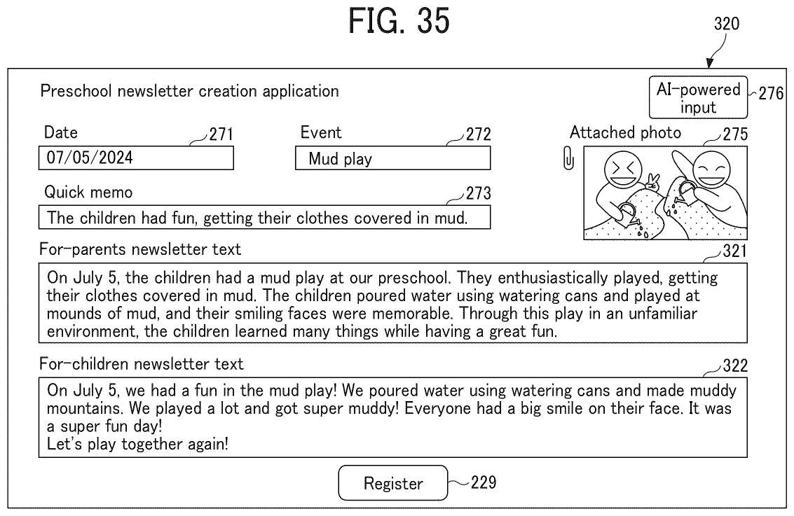

FIG. 35 illustrates an example of the input screen 320 of the preschool newsletter creation application in which the generated values are displayed by the preschool newsletter creation application. The input processing unit 14 inputs the values corresponding to the respective input items to the respective input fields of the input items. That is, the “for-parents newsletter text” 351 and the “for-children newsletter text” 352 generated by the generative AI system 50 and illustrated in FIG. 34 are respectively displayed in the for-parents newsletter input field 321 and the for-children newsletter input field 322.

As described above, the user inputs values for some of the input items of the preschool newsletter creation application, so that values can be automatically set for a plurality of selected input items that are left blank.

The confirmation dialog 290 illustrated in FIG. 27 may be displayed before the two texts generated by the generative AI system 50 are displayed on the input screen 320 of the preschool newsletter creation application. In this case, the user is preferably allowed to select the text to be generated again. The prompt input screen 280 illustrated in FIG. 25 is preferably displayed in response to the user pressing the generate again button 293. This allows the user to designate how the user desires to improve the text generated by the generative AI system 50 for each text.

The present embodiment provides the effects of the first embodiment. In addition, with a single request message, the generative AI system 50 can be requested to generate the values of the plurality of input items. This can speed up the processing and reduce the use fee of the generative AI system 50.

### Few-Shot Prompting

There is a technique called few-shot prompting for increasing the accuracy in the generation of a value by providing the generative AI system 50 with some output examples in the prompt. In the present embodiment, few-shot prompting is performed. This can increase the accuracy in the generation of the generated value of the input item.

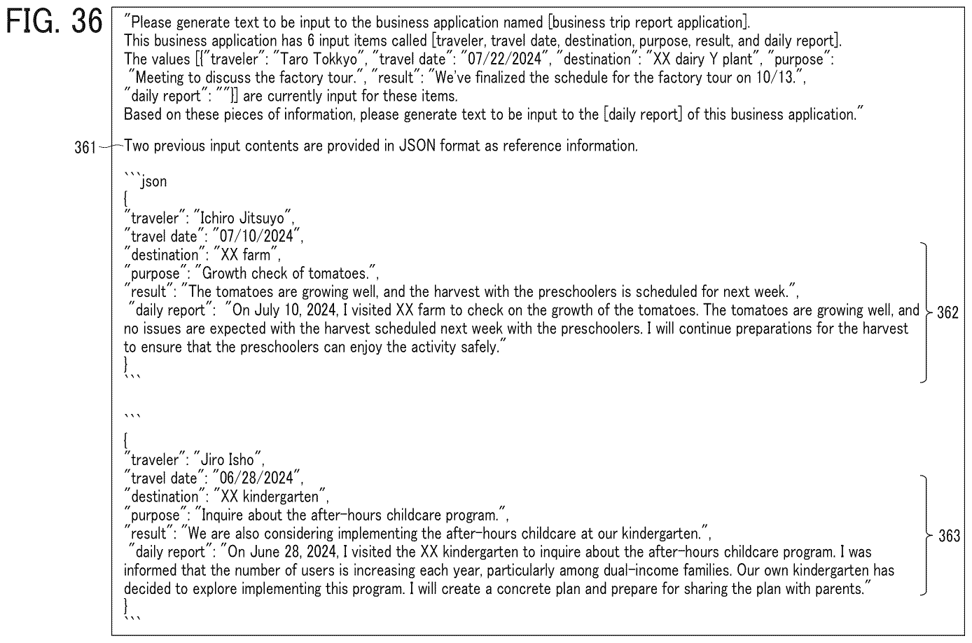

FIG. 36 illustrates an example of a prompt using few-shot prompting. Few-shot prompting is a technique involving the inclusion of one or more output examples in the prompt. Thus, the request generation unit 46a includes the information (FIG. 8) that has been registered to the application service 40 in the prompt. In FIG. 36, differences from FIG. 15 will be described.

A message 361 “Two previous input contents are provided in JSON format as reference information.” indicates that the following is the information that has been registered in the application.

A sample 362 is the first input content. In the sample 362, values of one record of the information already registered in the application are written in association with the respective label items, which are information related to the input items.

A sample 363 is the second input content. In the sample 363, values of one record of the information already registered in the application are written in association with the respective label items, which are information related to the input items.

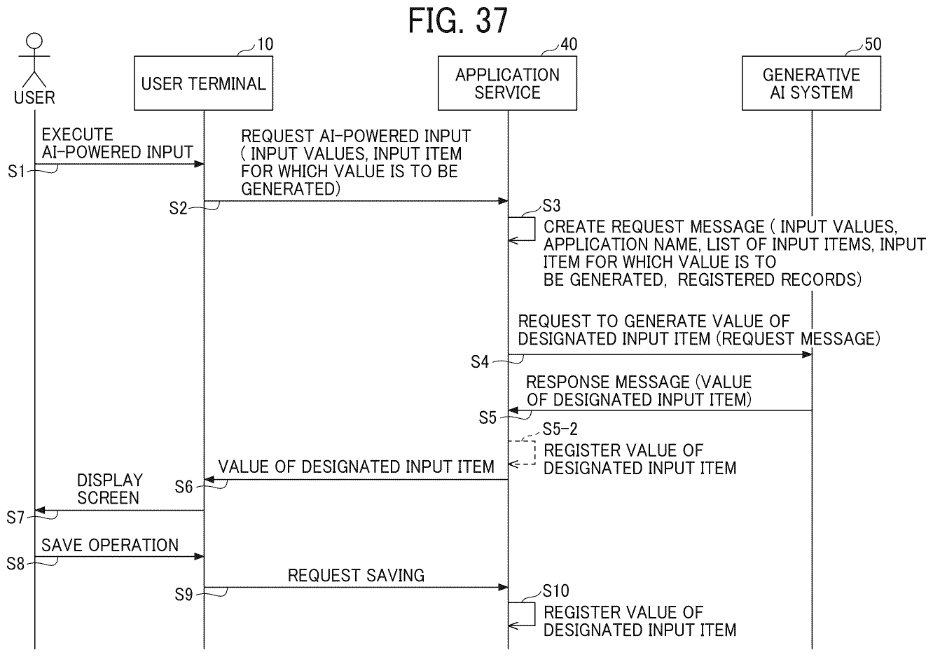

FIG. 37 is a sequence diagram for describing an example of a process performed by the information processing system 100 when few-shot prompting is used. In FIG. 37, differences from FIG. 10 will be described. In FIG. 37, processing in steps S3 and S5 is different from that in FIG. 10.
S3: The reception unit 41a of the application service 40 receives a request for AI-powered input. The method of identifying the list of input items and the application name may be the same as that used in FIG. 10. The application identification unit 44b identifies one or more already registered records of the application (e.g., the business trip report application) executed by the user terminal 10, from the application information identified by the identification information of the application.

The request generation unit 46a of the application service 40 generates a request message using the application-related information (e.g., the list of input items, the previously input values, and the application name), the input item for which a value is to be generated, and the already registered records. This request message includes an instruction to extract information corresponding to the designated input item.
S4: The request transmission unit 46b transmits a request to generate a value of the input item to the generative AI system 50 together with this request message.
S5: The generative AI system 50 analyzes the list of input items, the previously input values, the application name, and the already registered records to generate the value of the designated input item. The generative AI system 50 transmits a response message (i.e., the value of the designated input item) to the application service 40.

The following processing may be substantially the same as that in FIG. 10.

Few-shot prompting makes it easier for the generative AI system 50 to generate an appropriate value for the designated input item, and the generation of text intended by the user can be expected.

The present embodiment provides the effects of the first embodiment. In addition, it becomes easier for the generative AI system 50 to generate an appropriate value for the designated input item, and the generation of text intended by the user can be expected.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, in the present embodiment, the application service 40 transmits the application-related information to the generative AI system 50. Alternatively, the application-related information may be stored in a predetermined server. In this case, the application service 40 transmits information designating the application-related information in the server to the generative AI system 50. The generative AI system 50 acquires the application-related information from the server and generates the value of the input item using the application-related information.

In the present embodiment, the JSON format is used to represent the value of the input item generated by the generative AI system 50. Alternatively, the value of the input item may be represented in another format such as XML or CSV.

In the present embodiment, the user terminal 10 sets the generated value for the input item of the application managed by the application service 40. Alternatively, the user terminal 10 may set the generated value for the input item of a native application that operates thereon. For example, when the user terminal 10 executes a spreadsheet application, the user terminal 10 may set the generated value to a cell of the spreadsheet application.

In the present embodiment, the application service 40 requests the generative AI system 50 to generate text. Alternatively, the application service 40 may request the generative AI system 50 to generate image data. For example, after the application service 40 causes the generative AI system 50 to generate the newsletter text in the preschool newsletter creation application, the application service 40 further requests the generative AI system 50 to generate an illustration based on the newsletter text. This allows the user terminal 10 to set an alternative illustration in the attached photo field 275 when there is no appropriate photo to be set to the attached photo field 275, for example. In addition, the application service 40 may request the generative AI system 50 to generate music data or video data using the previously input values.

The apparatuses or devices described in the one or more embodiments are just one example of plural computing environments that implement the one or more embodiments disclosed herein. In one embodiment, the application service 40 includes multiple computing devices such as a server cluster. The multiple computing devices communicate with one another through any type of communication link including a network, a shared memory, or the like and perform the processes disclosed herein.

The application service 40 may share the processing steps disclosed in the embodiments of the present disclosure, for example, steps of FIG. 10 or the like in various combinations. For example, a process executed by a predetermined unit may be executed by multiple information processing apparatuses included in the application service 40. The application service 40 may be integrated into one server apparatus or divided into multiple apparatuses.

In the example configurations illustrated in FIG. 7, the application service 40 is divided according to the functions thereof to facilitate understanding of the processes performed by the application service 40. No limitation on the present disclosure is intended by how the functions are divided by process or by the name of the functions. The processes performed by the application service 40 may be divided into more units of processing in accordance with the content of the processing. In addition, the division may be performed so that one processing unit contains more processes.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The present disclosure provides significant improvements in computer capabilities and functionalities. These improvements allow a user to utilize a computer which provides for more efficient and robust interaction with a table which is a way to store and present information in an information processing apparatus. Moreover, the present disclosure provides for a better user experience through the use of a more efficient, powerful and robust user interface. Such a user interface provides for a better interaction between a human and a machine.

### Aspects

According to Aspect 1, an information processing apparatus to be connected to a terminal apparatus and a generative AI system via a network includes a registration unit, a request transmission unit, a response reception unit, and a transmission unit.

The registration unit registers information input via a screen displayed by the terminal apparatus. The screen includes a plurality of input fields to receive input of pieces of data to be input for a plurality of items by a user. The plurality of input fields includes a specific input field to receive input of text. The screen receives an operation for generating the text to be input to the specific input field.

In a case where the operation is received from the user, the request transmission unit transmits a request to the generative AI system. The request includes information indicating one or more items among the plurality of items, pieces of data input in input fields corresponding to the one or more items by the user, and an instruction. The one or more items are other than a specific item related to the specific input field among the plurality of items. The instruction is an instruction to generate the text to be input to the specific input field of the specific item based on the information indicating the one or more items and the pieces of data input in the input fields corresponding to the one or more items.

The response reception unit receives the text to be input to the specific input field from the generative AI system. The text serves as a response to the request.

The transmission unit transmits the text generated by the generative AI system based on the request to the terminal apparatus.

According to Aspect 2, the information processing apparatus of Aspect 1 further includes a request generation unit. The request generation unit generates the request.

According to Aspect 3, in the information processing apparatus of Aspect 1 or 2, the transmission unit transmits the text generated by the generative AI system and to be input to the specific input field to the terminal apparatus to cause the terminal apparatus to display the text in the specific input field.

According to Aspect 4, the information processing apparatus of any one of Aspects 1 to 3 further includes a reception unit, an application identification unit, and an item identification unit. The reception unit receives, from the terminal apparatus, information for identifying an application selected by the user.

The application identification unit identifies the application based on the information for identifying the application.

The item identification unit identifies items associated with the application.

According to Aspect 5, in the information processing apparatus of any one of Aspects 1 to 4, the instruction includes an instruction to generate text that meets a constraint for the specific input field of the specific item.

According to Aspect 6, in the information processing apparatus of Aspect 4, the instruction includes a name of the application.

According to Aspect 7, in the information processing apparatus of Aspect 4, the application includes an application created by receiving setting of the plurality of items from a user.

According to Aspect 8, in the information processing apparatus of any one of Aspects 1 to 7, the transmission unit transmits one or more programs to be executed by the terminal apparatus to the terminal apparatus.

The terminal apparatus executes a web browser.

An input processing unit that inputs, to the specific input field, the text to be input to the specific input field and received by the terminal apparatus operates as a result of the web browser executing the one or more programs transmitted from the information processing apparatus.

According to Aspect 9, in the information processing apparatus of Aspect 4,
the request transmission unit further includes one or more records already registered to the application in the request, and transmit the request to the generative AI system.

According to Aspect 10, in the information processing apparatus of Aspect 1, the request transmission unit transmits, in the case where the operation is received from the user, the request to the generative AI system.

The request includes the information indicating the one or more items other than the specific item related to the specific input field among the plurality of items and an instruction to generate text to be input to the specific input field of the specific item based on the information indicating the one or more items but
does not include the pieces of data input in the input fields corresponding to the one or more items by the user.

1. An information processing apparatus communicably connected with a terminal apparatus and a generative AI system via a network, the information processing apparatus comprising:
circuitry configured to:
register information input via a screen displayed by the terminal apparatus, the screen including a plurality of input fields for receiving inputs of data for a plurality of items from a user, the plurality of input fields including a specific input field for receiving input of text, the screen receiving an instruction to generate the text to be input to the specific input field; and
in a case where the instruction is received from the user,
transmit a request to the generative AI system, the request including
information indicating one or more items of the plurality of items other than a specific item of the specific input field, and
an instruction to generate the text to be input to the specific input field of the specific item based on the information indicating the one or more items,
receive the text to be input to the specific input field from the generative AI system in response to the request, and
transmit the text generated by the generative AI system based on the request to the terminal apparatus.

2. The information processing apparatus according to claim 1, wherein the request further includes
data input by the user in one or more input fields corresponding to the one or more items, and
the instruction to generate the text is further based on the data input in the one or more input fields.

3. The information processing apparatus according to claim 2, wherein the circuitry is configured to generate the request.

4. The information processing apparatus according to claim 2, wherein the circuitry is configured to transmit the text generated by the generative AI system and to be input to the specific input field to the terminal apparatus to cause the terminal apparatus to display the text in the specific input field.

5. The information processing apparatus according to claim 2, wherein the circuitry is configured to:
receive, from the terminal apparatus, information for identifying an application selected by the user;
identify the application based on the information for identifying the application; and
identify items associated with the application.

6. The information processing apparatus according to claim 2, wherein the instruction includes an instruction to generate text that meets a constraint for the specific input field of the specific item.

7. The information processing apparatus according to claim 5, wherein the instruction includes a name of the application.

8. The information processing apparatus according to claim 5, wherein the application includes an application created by receiving setting of the plurality of items from the user.

9. The information processing apparatus according to claim 2, wherein
the circuitry is configured to transmit one or more programs to the terminal apparatus,
the one or more programs causing, when executed by a web browser of the terminal apparatus, the terminal apparatus to input the text to the specific input field.

10. The information processing apparatus according to claim 5, wherein the circuitry is further configured to transmit the request to the generative AI system, the request including one or more records having been registered to the application.

11. An information processing system comprising:
the information processing apparatus according to claim 2; and
the terminal apparatus communicatively connected with the information processing apparatus via the network.

12. A terminal apparatus communicably connected with an information processing apparatus via a network, the terminal apparatus comprising:
circuitry configured to:
display a screen, the screen including a plurality of input fields for receiving inputs of data for a plurality of items from a user, the plurality of input fields including a specific input field for receiving input of text, the screen receiving an instruction to generate the text to be input to the specific input field; and
in a case where the instruction is received on the screen,
transmit a request to the information processing apparatus, the request including
information indicating one or more items of the plurality of items other than a specific item of the specific input field,
data input by the user in one or more input fields corresponding to the one or more items, and
an instruction to generate the text to be input to the specific input field of the specific item, based on the information indicating the one or more items and the data input in the one or more input fields,
receive the text to be input to the specific input field from the information processing apparatus, the text being acquired in response to the information processing apparatus transmitting the request to a generative AI system,
input the received text to the specific input field, and
transmit the text input in the specific input field to the information processing apparatus, the text to be managed by the information processing apparatus.

13. An information processing method comprising:
registering information input via a screen displayed by a terminal apparatus, the screen including a plurality of input fields for receiving inputs of data for a plurality of items from a user, the plurality of input fields including a specific input field for receiving input of text, the screen receiving an instruction to generate the text to be input to the specific input field,
wherein, in a case where the instruction is received from the user, the method further comprising:
transmitting a request to a generative AI system, the request including
information indicating one or more items of the plurality of items other than a specific item of the specific input field,
data input by the user in one or more input fields corresponding to the one or more items, and
an instruction to generate the text to be input to the specific input field of the specific item, based on the information indicating the one or more items and the data input in the one or more input fields;
receiving the text to be input to the specific input field from the generative AI system in response to the request; and
transmitting the text generated by the generative AI system based on the request to the terminal apparatus.
